(19) United States
(12) Patent Application Publication
(10) Pub. No.: US 2025/0011656 A1
(43) Pub. Date: Jan. 9, 2025

(54) METHODS AND SYSTEMS FOR SYNTHESIZING FUEL FROM CARBON DIOXIDE

(71) Applicant: CARBON ENGINEERING ULC, Squamish (CA)

(72) Inventors: Kenton Robert Heidel, Squamish (CA); Kyle Wayne Kemp, Burnaby (CA); Job Van de Panne, Calgary (CA); Tim Johnson, Vancouver (CA); Caroline Jiwon Jung, Vancouver (CA); Hai Ming Lai, Vancouver (CA); Pawanjot Kaur Gill, Vancouver (CA); Jane Anne Ritchie, Calgary (CA); Marcus Temke, Vancouver (CA)

(21) Appl. No.: 18/710,984

(22) PCT Filed: Nov. 21, 2022
(86) PCT No.: PCT/EP2022/082632

§ 371 Date: May 16, 2024

Related U.S. Application Data
(60) Provisional application No. 63/281,444, filed on Nov. 19, 2021.

(51) Int. Cl. C10G 2/00; B01D 53/62; B01D 53/75; C25B 1/04; C25B 1/23; C25B 11/043; C25B 11/063

(52) U.S. Cl. CPC C10G 2/33; B01D 53/62; B01D 53/75; C25B 1/04; C25B 1/23; C25B 11/043; C25B 11/063; B01D 2251/202; B01D 2257/504

(57) ABSTRACT

A method for producing a synthetic fuel includes extracting carbon dioxide (CO₂) from a flow of atmospheric air with a sorbent material to form a recovered carbon dioxide feed stream; extracting hydrogen (H₂) from a hydrogen-containing feedstock to produce a hydrogen feed stream; processing the recovered carbon dioxide feed stream in a CO₂ reduction reactor to produce a carbon monoxide (CO) stream by applying an electric potential to the CO₂ reduction reactor and reducing at least a portion of the recovered carbon dioxide feed stream over a catalyst to form the carbon monoxide stream and an oxygen (O₂) stream; and reacting the carbon monoxide stream from the CO₂ reduction reactor with the hydrogen feed stream to produce the synthetic fuel.

### TECHNICAL FIELD

This disclosure relates generally to methods and systems for synthesizing a fuel from carbon dioxide (CO₂).

### BACKGROUND

Global incentive for reducing CO₂ emissions is gaining momentum. Capturing carbon dioxide (CO₂) from the atmosphere, also known as Direct Air Capture (DAC), is one approach to mitigating greenhouse gas emissions and slowing climate change. However, many technologies designed for CO₂ capture from point sources, such as from flue gas of industrial facilities, are generally ineffective in capturing CO₂ from the atmosphere due to the significantly lower CO₂ concentrations and large volumes of atmospheric air required to process. In recent years, progress has been made in finding technologies better suited to capture CO₂ directly from the atmosphere. These technologies include the use of solid sorbents and liquid sorbents to extract and recover CO₂ from dilute sources like atmospheric air. There are several attractive utilization pathways for CO₂ after it has been captured and recovered. Some uses that are highly incentivized are synthesizing low carbon intensity fuels, such as transportation fuels, and chemicals using carbon sourced from the atmospheric CO₂.

Emissions reductions in the transportation sector have been acknowledged as being particularly challenging and costly. The vast majority of vehicles, including automobiles, ships, aircraft, and trains, combust high energy density hydrocarbon fuels, and roughly $50 trillion of infrastructure exists globally to produce, distribute, and consume these fuels. DAC provides a pathway for producing synthetic hydrocarbon fuels that have a similarly high energy density as conventional fuels, but are produced using carbon atoms that have already been emitted, thereby having a comparatively lower carbon intensity. When incorporated with renewable energy sources and optimized heat integration, these synthetic fuels can have low or zero carbon intensity. As these synthetic fuels are built from clean feedstock ingredients such as atmospheric CO₂ and hydrogen, they produce cleaner burning fuel products than fossil fuels. Thus, the demand for fuels and the need for emissions reductions can both be addressed by DAC-based synthetic fuels and chemicals.

### SUMMARY

In an example implementation, a method for producing a synthetic fuel includes extracting carbon dioxide (CO₂) from a flow of atmospheric air with a sorbent material to form a recovered carbon dioxide feed stream; extracting hydrogen (H₂) from a hydrogen-containing feedstock to produce a hydrogen feed stream; processing the recovered carbon dioxide feed stream in a CO₂ reduction reactor to produce a carbon monoxide (CO) stream by: applying an electric potential to the CO₂ reduction reactor; and reducing at least a portion of the recovered carbon dioxide feed stream over a catalyst to form the carbon monoxide stream and an oxygen (O₂) stream; and reacting the carbon monoxide stream from the CO₂ reduction reactor with the hydrogen feed stream to produce the synthetic fuel.

In an aspect combinable with the example implementation, extracting the carbon dioxide from the flow of atmospheric air with the sorbent material to form the recovered carbon dioxide feed stream includes reacting the carbon dioxide in the flow of atmospheric air with a CO₂ capture solution to form a CO₂-lean gas and a carbonate-rich capture solution; reacting the carbonate-rich capture solution with a calcium hydroxide stream to form at least a portion of the CO₂ capture solution and to precipitate calcium carbonate solids; and calcining at least a portion of the calcium carbonate solids to extract the recovered carbon dioxide feed stream.

In another aspect combinable with any of the previous aspects, reacting the carbon dioxide in the flow of atmospheric air with the CO₂ capture solution includes reacting the carbon dioxide in the flow of atmospheric air with at least one of potassium hydroxide or sodium hydroxide.

In another aspect combinable with any of the previous aspects, calcining at least the portion of the calcium carbonate solids includes combusting a fuel including at least one of natural gas or hydrogen.

In another aspect combinable with any of the previous aspects, combusting the fuel including at least one of natural gas or hydrogen includes combusting at least a portion of the hydrogen feed stream.

In another aspect combinable with any of the previous aspects, calcining at least the portion of the calcium carbonate solids includes electrically heating the calcium carbonate solids.

In another aspect combinable with any of the previous aspects, reacting the carbon monoxide stream from the CO₂ reduction reactor with the hydrogen feed stream includes: reacting the hydrogen feed stream and the carbon monoxide stream in a Fischer-Tropsch (FT) process to form an FT crude stream; refining the FT crude stream to form a refined crude stream including naphtha; and the method further includes combusting at least a portion of the naphtha to generate thermal energy, wherein calcining at least the portion of the calcium carbonate solids includes calcining at least the portion of the calcium carbonate solids with the thermal energy.

In another aspect combinable with any of the previous aspects, extracting hydrogen from the hydrogen-containing feedstock includes electrolyzing water to form the hydrogen feed stream and an electrolyzer oxygen stream.

In another aspect combinable with any of the previous aspects, extracting hydrogen from the hydrogen-containing feedstock includes steam-methane reforming to form the hydrogen feed stream.

In another aspect combinable with any of the previous aspects, reacting the carbon monoxide stream from the CO₂ reduction reactor with the hydrogen feed stream includes reacting the hydrogen feed stream and the carbon monoxide stream in a Fischer Tropsch (FT) process to form an FT crude stream.

In another aspect combinable with any of the previous aspects, processing the recovered carbon dioxide feed stream in the CO₂ reduction reactor includes conveying only the carbon monoxide stream from the CO₂ reduction reactor to a Fischer-Tropsch (FT) process; and reacting the carbon monoxide stream from the CO₂ reduction reactor with the hydrogen feed stream includes reacting the carbon monoxide stream conveyed from the CO₂ reduction reactor with the hydrogen feed stream in the FT process to form an FT crude stream.

Another aspect combinable with any of the previous aspects further includes oxidizing at least a portion of a combustible gas using the oxygen stream from the CO₂ reduction reactor in an autothermal reformer to form a syngas stream.

In another aspect combinable with any of the previous aspects, reacting the carbon monoxide stream from the CO₂ reduction reactor with the hydrogen feed includes reacting the carbon monoxide stream from the CO₂ reduction reactor with the hydrogen feed stream in a Fischer Tropsch (FT) process to form an FT crude stream and an FT tail gas stream; and the method further includes refining the FT crude stream to produce a refined tail gas stream and a refined crude stream.

In another aspect combinable with any of the previous aspects, oxidizing at least the portion of the combustible gas includes oxidizing at least one of the FT tail gas stream, the refined tail gas stream, or a natural gas stream.

In another aspect combinable with any of the previous aspects, reacting the carbon monoxide stream from the CO₂ reduction reactor with the hydrogen feed stream includes reacting, in a Fischer Tropsch (FT) process, the syngas stream from the autothermal reformer, the carbon monoxide stream and the hydrogen feed stream to form an FT crude stream and an FT tail gas stream.

In another aspect combinable with any of the previous aspects, reacting the carbon monoxide stream from the CO₂ reduction reactor with the hydrogen feed stream includes: refining the FT crude stream to form a refined crude stream and a refined tail gas stream; and distilling the refined crude stream to form the synthetic fuel, the synthetic fuel including a liquid fuels stream and a chemicals stream.

In another aspect combinable with any of the previous aspects, extracting hydrogen from hydrogen compounds in the hydrogen feedstock to produce the hydrogen feed stream further includes dissociating a water stream over the catalyst in the CO₂ reduction reactor to form the hydrogen feed stream and another portion of the oxygen stream.

In another aspect combinable with any of the previous aspects, reacting the carbon monoxide stream from the CO₂ reduction reactor with the hydrogen feed stream includes: reacting the hydrogen feed stream and the carbon monoxide stream via a Fischer-Tropsch (FT) process to form an FT tail gas stream and an FT crude stream; and refining the FT crude stream to form a refined tail gas stream and a refined crude stream; and calcining at least the portion of the calcium carbonate solids to extract the recovered carbon dioxide feed stream includes combusting at least one of the FT tail gas stream or the refined tail gas stream.

In another aspect combinable with any of the previous aspects, the recovered carbon dioxide feed stream includes excess oxygen; and the method further includes removing at least a portion of the excess oxygen in the recovered carbon dioxide feed stream.

In another aspect combinable with any of the previous aspects, removing at least the portion of the excess oxygen in the recovered carbon dioxide feed stream includes combusting at least the portion of the excess oxygen with a fuel, wherein a molar ratio of the fuel to the excess oxygen is equal to or greater than a combustion stoichiometric ratio.

In another aspect combinable with any of the previous aspects, removing at least the portion of the excess oxygen in the recovered carbon dioxide feed stream includes: catalytically oxidizing a combustible gas with at least the portion of the excess oxygen to form a catalytic oxidation product stream including carbon dioxide and water; and combining the carbon dioxide of the catalytic oxidation product stream with the recovered carbon dioxide feed stream, wherein the combustible gas includes at least one of natural gas, a Fischer-Tropsch tail gas, or a refined tail gas.

In another aspect combinable with any of the previous aspects, catalytically oxidizing the combustible gas with at least the portion of the excess oxygen includes: combusting at least the portion of the excess oxygen with the combustible gas at an auto-ignition temperature of the combustible gas.

Another aspect combinable with any of the previous aspects further includes liquefying the recovered carbon dioxide feed stream; and maintaining at least a portion of the liquefied carbon dioxide feed stream in a liquid storage tank before processing the recovered carbon dioxide feed stream in the CO₂ reduction reactor.

In another aspect combinable with any of the previous aspects, liquefying the recovered carbon dioxide feed stream includes separating contaminants from the recovered carbon dioxide feed stream in at least one of a cryogenic distillation unit, a membrane separation unit, or water knockout unit.

In another aspect combinable with any of the previous aspects, reacting the carbon monoxide stream from the CO₂ reduction reactor with the hydrogen feed stream generates heat; and the method further includes transferring at least a portion of the heat to the step of extracting the carbon dioxide from the flow of atmospheric air with the sorbent material to form the recovered carbon dioxide feed stream.

In another aspect combinable with any of the previous aspects, extracting the carbon dioxide from the flow of atmospheric air with the sorbent material to form the recovered carbon dioxide feed stream includes calcining calcium carbonate solids with at least a portion of the heat to extract the recovered carbon dioxide feed stream.

In another aspect combinable with any of the previous aspects, extracting the carbon dioxide from the flow of atmospheric air with the sorbent material to form the recovered carbon dioxide feed stream includes transferring at least a portion of the heat to a CO₂ capture solution and reacting the carbon dioxide in the flow of atmospheric air with the CO₂ capture solution.

In another aspect combinable with any of the previous aspects, extracting the carbon dioxide from the flow of atmospheric air includes: maintaining at least one of solid calcium carbonate or solid calcium oxide in a solids buffer storage tank before processing the recovered carbon dioxide feed stream in the CO₂ reduction reactor.

Another aspect combinable with any of the previous aspects further includes compressing a gaseous process stream by operating a single compressor assembly, the gaseous process stream including at least one of the recovered carbon dioxide feed stream, steam, carbon monoxide, hydrogen, a Fischer-Tropsch tail gas, or a refined tail gas.

In another aspect combinable with any of the previous aspects, extracting the carbon dioxide from the flow of atmospheric air includes: reacting the carbon dioxide in the flow of atmospheric air with a solid sorbent including at least one of a metal oxide or a metal hydroxide to form carbonate-containing solids; and calcining at least a portion of the carbonate-containing solids to extract the recovered carbon dioxide feed stream.

In another aspect combinable with any of the previous aspects, reacting the carbon monoxide stream from the CO₂ reduction reactor with the hydrogen feed stream includes reacting the hydrogen feed stream and the carbon monoxide stream through a Fischer-Tropsch (FT) process to form an FT tail gas stream and an FT crude stream; and refining the FT crude stream to form a refined tail gas stream and a refined crude stream, wherein calcining at least the portion of the carbonate-containing solids includes combusting at least one of the FT tail gas stream or the refined tail gas stream.

In another example implementation, a method for producing a synthetic fuel includes: extracting carbon dioxide from a flow of atmospheric air with a sorbent material to form a recovered carbon dioxide feed stream; extracting hydrogen from a hydrogen-containing feedstock to produce a hydrogen feed stream; processing the recovered carbon dioxide feed stream in a carbon dioxide (CO₂) reduction reactor to produce a carbon monoxide (CO) stream by: conveying a portion of the hydrogen feed stream and at least a portion of the recovered carbon dioxide feed stream to the CO₂ reduction reactor; and applying a thermal energy input to the CO₂ reduction reactor to react the portion of the hydrogen feed stream with the recovered carbon dioxide feed stream over a catalyst in the CO₂ reduction reactor to produce the carbon monoxide stream and a water stream; and reacting the carbon monoxide stream from the CO₂ reduction reactor with the hydrogen feed stream to produce the synthetic fuel.

In another aspect combinable with any of the previous aspects, extracting the carbon dioxide from the flow of atmospheric air with the sorbent material to form the recovered carbon dioxide feed stream includes reacting the carbon dioxide in the flow of atmospheric air with a CO₂ capture solution to form a CO₂-lean gas and a carbonate-rich capture solution; reacting the carbonate-rich capture solution with a calcium hydroxide stream to form at least a portion of the CO₂ capture solution and to precipitate calcium carbonate solids; and calcining at least a portion of the calcium carbonate solids to extract the recovered carbon dioxide feed stream.

In another aspect combinable with any of the previous aspects, reacting the carbon dioxide in the flow of atmospheric air with the CO₂ capture solution includes reacting the carbon dioxide in the flow of atmospheric air with at least one of potassium hydroxide or sodium hydroxide.

In another aspect combinable with any of the previous aspects, calcining at least the portion of the calcium carbonate solids includes combusting a fuel including at least one of natural gas or hydrogen.

In another aspect combinable with any of the previous aspects, calcining at least the portion of the calcium carbonate solids includes electrically heating the calcium carbonate solids.

In another aspect combinable with any of the previous aspects, combusting the fuel including at least one of natural gas or hydrogen includes at least a portion of the hydrogen feed stream.

In another aspect combinable with any of the previous aspects, reacting the carbon monoxide stream from the CO₂ reduction reactor with the hydrogen feed stream includes: reacting the hydrogen feed stream and the carbon monoxide stream in a Fischer-Tropsch (FT) process to form an FT crude stream; and refining the FT crude stream to form a refined crude stream including naphtha; and the method further includes: combusting at least a portion of the naphtha to generate thermal energy, wherein calcining at least the portion of the calcium carbonate solids includes calcining at least the portion of the calcium carbonate solids with the thermal energy.

In another aspect combinable with any of the previous aspects, extracting hydrogen from the hydrogen-containing feedstock includes electrolyzing water to form the hydrogen feed stream and an electrolyzer oxygen stream.

In another aspect combinable with any of the previous aspects, extracting hydrogen from the hydrogen-containing feedstock includes steam-methane reforming to form the hydrogen feed stream.

In another aspect combinable with any of the previous aspects, reacting the carbon monoxide stream from the CO₂ reduction reactor with the hydrogen feed stream includes reacting the hydrogen feed stream and the carbon monoxide stream in a Fischer-Tropsch (FT) process to form an FT crude stream.

In another aspect combinable with any of the previous aspects, applying the thermal energy input to react at least a portion of the hydrogen feed stream and the recovered CO₂ feed stream in the CO₂ reduction reactor includes executing a reverse water gas shift reaction.

In another aspect combinable with any of the previous aspects, extracting hydrogen from the hydrogen-containing feedstock includes electrolyzing water to form the hydrogen feed stream and an electrolyzer oxygen stream; and the method further includes oxidizing at least a portion of a combustible gas using the electrolyzer oxygen stream in an autothermal reformer to form a syngas stream, the combustible gas including at least one of an a Fischer-Tropsch (FT) tail gas stream, a refined tail gas stream, or a natural gas stream.

In another aspect combinable with any of the previous aspects, applying the thermal energy input to the CO₂ reduction reactor includes applying the thermal energy input to react the syngas stream from the autothermal reformer in the CO₂ reduction reactor to form the carbon monoxide stream and the water stream.

In another aspect combinable with any of the previous aspects, reacting the carbon monoxide stream from the CO₂ reduction reactor with the hydrogen feed stream includes reacting the carbon monoxide stream with at least a portion of the hydrogen feed stream in a FT process to form the FT crude stream and the FT tail gas stream.

Another aspect combinable with any of the previous aspects further includes refining the FT crude stream to form a refined crude stream and the refined tail gas stream; and distilling the refined crude stream to form the synthetic fuel, the synthetic fuel including a liquid fuels stream and a chemicals stream.

In another aspect combinable with any of the previous aspects, reacting the carbon monoxide stream from the CO₂ reduction reactor with the hydrogen feed stream includes: reacting the hydrogen feed stream and the carbon monoxide stream via a Fischer-Tropsch (FT) process to form an FT tail gas stream and an FT crude stream; and refining the FT crude stream to form a refined tail gas stream and a refined crude stream; and calcining the at least a portion of calcium carbonate solids to extract the recovered carbon dioxide feed stream includes combusting at least one of the FT tail gas stream or the refined tail gas stream.

In another aspect combinable with any of the previous aspects, the recovered carbon dioxide feed stream includes excess oxygen; and the method further includes removing at least a portion of the excess oxygen in the recovered carbon dioxide feed stream.

In another aspect combinable with any of the previous aspects, removing at least the portion of the excess oxygen in the recovered carbon dioxide feed stream includes: combusting at least the portion of the excess oxygen with a fuel, wherein a molar ratio of the fuel to the excess oxygen is equal to or greater than a combustion stoichiometric ratio.

In another aspect combinable with any of the previous aspects, removing at least the portion of the excess oxygen in the recovered carbon dioxide feed stream includes: catalytically oxidizing a combustible gas with at least the portion of the excess oxygen to form a catalytic oxidation product stream including carbon dioxide and water, wherein the combustible gas includes at least one of natural gas, an FT tail gas, or a refined tail gas; and combining the carbon dioxide of the catalytic oxidation product stream with the recovered carbon dioxide feed stream.

In another aspect combinable with any of the previous aspects, catalytically oxidizing the combustible gas with at least the portion of the excess oxygen includes: combusting at least the portion of the excess oxygen with the combustible gas at an auto-ignition temperature of the combustible gas.

Another aspect combinable with any of the previous aspects further includes liquefying the recovered carbon dioxide feed stream; and maintaining at least a portion of the liquefied carbon dioxide feed stream in a liquid storage tank before processing the recovered carbon dioxide feed stream in the CO₂ reduction reactor.

In another aspect combinable with any of the previous aspects, liquefying the recovered carbon dioxide feed stream includes separating contaminants from the recovered carbon dioxide feed stream in at least one of a cryogenic distillation unit, a membrane separation unit, or water knockout unit.

In another aspect combinable with any of the previous aspects, reacting the carbon monoxide stream from the CO₂ reduction reactor with the hydrogen feed stream generates heat; and the method further includes transferring at least a portion of the heat to the step of extracting the carbon dioxide from the flow of atmospheric air with the sorbent material.

In another aspect combinable with any of the previous aspects, extracting the carbon dioxide from the flow of atmospheric air with the sorbent material to form the recovered carbon dioxide feed stream includes calcining at least a portion of calcium carbonate solids to extract the recovered carbon dioxide feed stream; and the method further includes transferring at least a portion of the heat to the calcium carbonate solids.

In another aspect combinable with any of the previous aspects, extracting the carbon dioxide from the flow of atmospheric air with the sorbent material to form the recovered carbon dioxide feed stream includes reacting the carbon dioxide in the flow of atmospheric air with a CO₂ capture solution; and the method further includes transferring at least a portion of the heat to the CO₂ capture solution.

In another aspect combinable with any of the previous aspects, extracting the carbon dioxide from the flow of atmospheric air includes: maintaining at least one of solid calcium carbonate or solid calcium oxide in a solids buffer storage tank before processing the recovered carbon dioxide feed stream in the CO₂ reduction reactor.

Another aspect combinable with any of the previous aspects further includes compressing a gaseous process stream by operating a single compressor assembly, the gaseous process stream including at least one of the recovered carbon dioxide feed stream, steam, carbon monoxide, hydrogen, a Fischer-Tropsch tail gas, or a refined tail gas.

In another aspect combinable with any of the previous aspects, extracting the carbon dioxide from the flow of atmospheric air includes: reacting the carbon dioxide in the flow of atmospheric air with a solid sorbent including at least one of a metal oxide or a metal hydroxide to form carbonate-containing solids; and calcining at least a portion of the carbonate-containing solids to extract the recovered carbon dioxide feed stream.

In another aspect combinable with any of the previous aspects, reacting the carbon monoxide stream from the CO₂ reduction reactor with the hydrogen feed stream includes: reacting the hydrogen feed stream and the carbon monoxide stream via an FT process to form an FT tail gas stream and an FT crude stream; and refining the FT crude stream to form a refined tail gas stream and a refined crude stream, wherein calcining at least the portion of the carbonate-containing solids includes combusting at least one of the FT tail gas stream or the refined tail gas stream.

In another example implementation, a method for producing a synthetic fuel includes: extracting carbon dioxide from a flow of atmospheric air with a sorbent material to form a recovered carbon dioxide feed stream; processing the recovered carbon dioxide feed stream in a carbon dioxide (CO₂) reduction reactor to produce a carbon monoxide (CO) stream by: applying an electric potential to the CO₂ reduction reactor; and reducing at least a portion of the recovered carbon dioxide feed stream over a catalyst to form the carbon monoxide stream and an oxygen (O₂) stream; and reacting the carbon monoxide stream from the CO₂ reduction reactor with a hydrogen (H₂) stream to produce the synthetic fuel.

In another example implementation, a method for producing a synthetic fuel includes: in a carbon dioxide (CO₂) reduction reactor, processing a CO₂ feed stream generated by capturing CO₂ from atmospheric air to produce a carbon monoxide (CO) stream by: applying an electric potential to the CO₂ reduction reactor; and reducing at least a portion of the CO₂ feed stream over a catalyst to form the carbon monoxide stream and an oxygen (O₂) stream; and reacting the carbon monoxide stream from the CO₂ reduction reactor with a hydrogen stream to produce the synthetic fuel.

In another example implementation, a system for producing a synthetic fuel includes: a carbon dioxide (CO₂) capture subsystem configured to extract carbon dioxide from a flow of atmospheric air with a sorbent material to produce a recovered carbon dioxide feed stream; a hydrogen production subsystem configured to extract hydrogen from a hydrogen-containing feedstock to produce a hydrogen feed stream; and a hydrocarbon production subsystem including a CO₂ reduction reactor configured to process the recovered carbon dioxide feed stream to produce a carbon monoxide (CO) stream, the hydrocarbon production subsystem configured to react the hydrogen feed stream with the carbon monoxide stream from the CO₂ reduction reactor to produce the synthetic fuel.

In another aspect combinable with any of the previous aspects, the sorbent material includes a CO₂ capture solution; and the CO₂ capture subsystem includes a pellet reactor fluidly coupled to a calciner, the pellet reactor configured to react the CO₂ capture solution to precipitate calcium carbonate solids and the calciner configured to calcine at least a portion of the calcium carbonate solids.

In another aspect combinable with any of the previous aspects, the CO₂ capture solution includes at least one of potassium hydroxide or sodium hydroxide.

In another aspect combinable with any of the previous aspects, the calciner is configured to combust a fuel including at least one of natural gas or hydrogen fuel.

In another aspect combinable with any of the previous aspects, the fuel includes the hydrogen fuel, the hydrogen fuel being a portion of the hydrogen feed stream.

In another aspect combinable with any of the previous aspects, the calciner includes an electrical heater.

In another aspect combinable with any of the previous aspects, the hydrogen production subsystem includes a water electrolyzer configured to form the hydrogen feed stream and an oxygen stream.

In another aspect combinable with any of the previous aspects, hydrogen production subsystem includes a steam-methane reformer operable to form the hydrogen feed stream and an oxygen stream.

In another aspect combinable with any of the previous aspects, the hydrocarbon production subsystem includes a Fischer-Tropsch (FT) reactor fluidly coupled to the CO₂ reduction reactor to receive the carbon monoxide stream from the CO₂ reduction reactor, the FT reactor configured to form an FT crude stream.

In another aspect combinable with any of the previous aspects, the CO₂ reduction reactor includes a solid oxide electrolysis cell including a zirconias-containing electrolyte and an electrode including nickel or platinum.

In another aspect combinable with any of the previous aspects, the CO₂ reduction reactor includes a molten carbonate electrolysis cell including a carbonate-containing electrolyte and an electrode including titanium or graphite.

In another aspect combinable with any of the previous aspects, the CO₂ reduction reactor includes a polymer electrolyte membrane fuel cell including at least one of an alkaline aqueous solution or a solid membrane.

In another aspect combinable with any of the previous aspects, the CO₂ reduction reactor includes a gas diffusion electrode and a catalyst including platinum or a non-precious metal.

In another aspect combinable with any of the previous aspects, the CO₂ reduction reactor is fluidly coupled to the CO₂ capture subsystem; and the hydrocarbon production subsystem includes an autothermal reformer fluidly coupled to a Fischer-Tropsch (FT) reactor.

In another aspect combinable with any of the previous aspects, the autothermal reformer includes a reactant inlet configured to receive a combustible gas including at least one of an FT tail gas from the FT reactor, a refined tail gas, or a natural gas stream.

In another aspect combinable with any of the previous aspects, the FT reactor includes a syngas inlet configured to receive a syngas stream from the autothermal reformer.

In another aspect combinable with any of the previous aspects, the FT reactor includes an FT catalyst including at least one of nickel, cobalt, iron, or ruthenium.

In another aspect combinable with any of the previous aspects, the CO₂ reduction reactor includes an oxygen outlet that is fluidly coupled to the autothermal reformer and a carbon monoxide outlet that is fluidly coupled to the FT reactor.

In another aspect combinable with any of the previous aspects, the CO₂ reduction reactor includes: a thermal energy source; at least one reactant inlet configured to receive the recovered carbon dioxide feed stream, a portion of the hydrogen feed stream, and a syngas stream from the autothermal reformer; an outlet configured to flow the carbon monoxide stream to the FT reactor; and a catalyst including at least one of cobalt, iron, copper, zinc, or aluminum.

In another aspect combinable with any of the previous aspects, the CO₂ reduction reactor is a fixed bed reactor or a multi-tubular fixed bed reactor.

In another aspect combinable with any of the previous aspects, the hydrogen production subsystem includes a water electrolyzer configured to provide the hydrogen feed stream to the CO₂ reduction reactor and configured to provide an oxygen stream to the autothermal reformer, the autothermal reformer including: a plurality of inlets configured to receive a plurality of reactants, the plurality of reactants including a combustible gas and the oxygen stream from the water electrolyzer, the combustible gas including at least one of an FT tail gas from the FT reactor, a refined tail gas, or a natural gas stream; an outlet fluidly coupled to the at least one reactant inlet of the CO₂ reduction reactor, the outlet configured to flow a syngas stream to the CO₂ reduction reactor; and a reforming furnace supporting a catalyst including nickel, the reforming furnace configured to oxidize at least a portion of the combustible gas with the oxygen stream to form the syngas stream.

In another aspect combinable with any of the previous aspects, the FT reactor includes a reactor volume containing a catalyst and at least one outlet configured to flow an FT tail gas to the autothermal reformer and an FT crude stream.

In another aspect combinable with any of the previous aspects, the FT reactor is one of a fixed packed bed reactor, a multi-tubular fixed bed reactor, a fluidized bed reactor, and a slurry phase reactor.

In another aspect combinable with any of the previous aspects, the hydrocarbon production subsystem includes an autothermal reformer fluidly coupled to refining units, the refining units fluidly coupled to a distillation unit, the refining units including at least one outlet configured to flow a refined tail gas to the autothermal reformer and a refined crude to the distillation unit, the distillation unit configured to fractionate the refined crude into the synthetic fuel.

In another aspect combinable with any of the previous aspects, the refined crude includes naphtha; and the CO₂ capture subsystem includes a calciner including a burner operable to combust the naphtha.

In another aspect combinable with any of the previous aspects, the CO₂ capture subsystem includes a calciner configured to combust a combustible gas to provide thermal energy for calcining calcium carbonate solids, the combustible gas including at least one of a Fischer-Tropsch (FT) tail gas or a refined tail gas.

In another aspect combinable with any of the previous aspects, the sorbent material includes a CO₂ capture solution; and the CO₂ capture subsystem includes a burner configured to combust a combustible gas to provide thermal energy for heating the CO₂ capture solution, the combustible gas including at least one of a Fischer-Tropsch (FT) tail gas or a refined tail gas.

In another aspect combinable with any of the previous aspects, the recovered carbon dioxide feed stream includes excess oxygen; and the system further includes a catalytic oxidation reactor coupled to the CO₂ capture subsystem, the catalytic oxidation reactor operable to remove at least a portion of the excess oxygen, the catalytic oxidation reactor including: a catalytic oxidation reactor volume containing a platinum-containing catalyst; and at least one inlet configured to receive the excess oxygen in the recovered carbon dioxide feed stream and to receive a combustible gas including at least one of natural gas, a Fischer-Tropsch (FT) tail gas, or a refined tail gas, the catalytic oxidation reactor volume configured to react the excess oxygen with the combustible gas over the platinum-containing catalyst.

In another aspect combinable with any of the previous aspects, the CO₂ reduction reactor includes a solid oxide electrolysis cell including a zirconias-containing electrolyte and an electrode containing nickel or platinum.

In another aspect combinable with any of the previous aspects, the CO₂ reduction reactor includes a molten carbonate electrolysis cell including a carbonate-containing electrolyte and an electrode containing titanium or graphite.

In another aspect combinable with any of the previous aspects, the CO₂ reduction reactor includes a polymer electrolyte membrane fuel cell including at least one of an alkaline aqueous solution or a solid membrane.

In another aspect combinable with any of the previous aspects, the CO₂ reduction reactor includes a gas diffusion electrode and a catalyst including platinum or a non-precious metal.

In another aspect combinable with any of the previous aspects, the CO₂ reduction reactor includes: a thermal energy source thermally coupled to a CO₂ reduction reactor vessel supporting a CO₂ reduction catalyst; at least one reactant inlet configured to receive reactants, the reactants including the recovered carbon dioxide feed stream, a portion of the hydrogen feed stream, and a syngas stream; and an outlet configured to flow products, the products including the carbon monoxide stream, wherein the CO₂ reduction reactor vessel is configured to react the reactants over the CO₂ reduction catalyst and the CO₂ reduction catalyst includes at least one of cobalt, iron, copper, zinc, or aluminum.

Another aspect combinable with any of the previous aspects further includes a CO₂ purification and compression system fluidly coupled to a liquid buffer storage tank configured to be pressurized to a pressure ranging between 10 bar to 65 bar, wherein the CO₂ capture subsystem is fluidly coupled to the hydrocarbon subsystem by the CO₂ purification and compression system and the liquid buffer storage tank.

In another aspect combinable with any of the previous aspects, the CO₂ purification and compression system includes at least one of a cryogenic distillation unit, a membrane separation unit, or water knockout unit.

In another aspect combinable with any of the previous aspects, the hydrocarbon production subsystem includes a Fischer-Tropsch (FT) reactor thermally coupled to the CO₂ capture subsystem.

In another aspect combinable with any of the previous aspects, the CO₂ capture subsystem includes a calciner, the FT reactor thermally coupled to the calciner.

In another aspect combinable with any of the previous aspects, the CO₂ capture subsystem includes a calciner fluidly coupled to at least one solids buffer storage tank configured to store at least one of calcium carbonate or calcium oxide.

Another aspect combinable with any of the previous aspects further includes a single compressor assembly fluidly coupled to the CO₂ capture subsystem and the hydrocarbon production subsystem, the single compressor assembly including a multi-stage compressor-motor or at least two compressors coupled to a single motor shaft.

In another aspect combinable with any of the previous aspects, the sorbent material of the CO₂ capture subsystem is a solid sorbent including at least one of a metal oxide or a metal hydroxide, and the CO₂ capture subsystem includes: a reactor configured to form carbonate-containing solids by reacting carbon dioxide in the flow of atmospheric air with the solid sorbent; and a calciner operable to calcine at least a portion of the carbonate-containing solids.

In another aspect combinable with any of the previous aspects, the hydrocarbon production subsystem includes: a Fischer-Tropsch (FT) reactor operable to form an FT tail gas and an FT crude stream; and refining units fluidly coupled to the FT reactor, the refining units operable to form a refined tail gas and a refined crude stream; and the calciner configured to combust at least one of the FT tail gas or the refined tail gas.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF DRAWINGS

FIG. 1 is a schematic block diagram of an example system for producing a synthetic fuel from hydrogen and carbon dioxide including a CO₂ capture subsystem, a hydrogen production sub-system, and a synthetic fuel production subsystem, according to the present disclosure.

FIG. 2 is a schematic diagram of an example system for producing synthetic fuels from CO₂ in atmospheric air that employs an electrocatalytic CO₂ reduction reactor and an autothermal reformer.

FIG. 3 is a schematic diagram of an example system for producing synthetic fuels from CO₂ in atmospheric air that employs a thermocatalytic CO₂ reduction reactor and an autothermal reformer.

FIG. 4 is a schematic diagram of an example system for producing synthetic fuels from CO₂ in atmospheric air that employs an electrocatalytic CO₂ reduction reactor and recycles an FT tail gas and a refined tail gas to a CO₂ capture subsystem.

FIG. 5 is a schematic diagram of an example system for producing synthetic fuels from CO₂ in atmospheric air that employs a thermocatalytic CO₂ reduction reactor and recycles a Fischer Tropsch (FT) tail gas and a refined tail gas to a CO₂ capture subsystem.

FIG. 6 is a schematic diagram of an example system for producing synthetic fuels from CO₂ in atmospheric air that employs buffer capacity and recycling of a liquid synthetic fuel within the system.

FIG. 7 is a schematic diagram of an example system that includes a catalytic oxidation reactor and a calciner combustion control system to remove at least a portion of excess oxygen from a recovered CO₂ stream.

FIG. 8 is a schematic diagram of an example system for producing synthetic fuels from CO₂ in atmospheric air that employs a CO₂ reduction reactor that produces a hydrogen stream and a CO stream.

FIG. 9A and FIG. 9B are schematic diagrams of example electrocatalytic CO₂ reduction reactors.

FIG. 10A and FIG. 10B are schematic diagrams of example thermocatalytic CO₂ reduction reactors.

FIG. 11A and FIG. 11B are schematic diagrams of example hydrogen production subsystems.

FIG. 12 is a schematic diagram of an example CO₂ capture subsystem that includes a liquid sorbent.

FIG. 13 is a schematic diagram of an example CO₂ capture subsystem including solid sorbents.

FIG. 14 is a schematic diagram of a control system (or controller) for a system for producing a synthetic fuel from hydrogen and carbon dioxide.

FIG. 15 is a flowchart of an example method for employing an electrocatalytic CO₂ reduction reactor to produce a synthetic fuel.

FIG. 16 is a flowchart of an example method for employing a thermocatalytic CO₂ reduction reactor to produce a synthetic fuel.

### DETAILED DESCRIPTION

The present disclosure describes systems and methods for synthesizing a fuel (“synfuel”) from a CO₂ source, such as from a dilute CO₂ source, e.g., atmospheric air or another fluid source that contains less than about 1 v/v % CO₂ content. Concentrations of CO₂ in the atmosphere are dilute, in that they are presently in the range of 400-420 parts per million (“ppm”) or approximately 0.04-0.042% v/v, and less than 1% v/v. These atmospheric concentrations of CO₂ are at least one order of magnitude lower than the concentration of CO₂ in point-source emissions, such as flue gases, where point-source emissions can have concentrations of CO₂ ranging from 5-15% v/v depending on the source of emissions.

When combined with hydrogen made using renewable energy or using conventional steam-methane reforming in combination with carbon capture, CO₂ capture from atmospheric air enables the production of carbon neutral synfuels like gasoline, diesel, and aviation turbine fuel that are compatible with today's fuel and transportation infrastructure. These synfuels may also overcome some of the current limitations of fats and biomass based biofuels including for example security of feedstocks, scale limitations, fuel blending constraints, land use, and food crop displacement. Furthermore, synfuels produced through the methods described herein can compare favorably to other renewable diesel options in that they can, for example, have one or more of higher energy content, higher cetane values, lower NOx emissions, and no sulphur content. The higher cetane synthetic diesel produced through the methods described herein can allow for blending with lower quality fossil stocks.

The carbon intensity of the synfuel can be especially reduced when the system uses atmospheric air as the CO₂ feedstock and uses a renewable, zero and/or low carbon power source to operate the system. Using such a low carbon intensity synfuel can allow for reduced emissions in transportation applications where electrical power, biofuel or other low carbon options are not practical, such as powering long-haul vehicles including trucks, aircraft, ships, and trains. Furthermore, the low carbon intensity synfuels produced through the methods described herein will likely qualify for numerous government policy revenues and/or credit schemes, including those from LCFS, RIN, and RED programs.

The impact of renewable electricity and fuel, used for example in oxy-fired equipment, on the carbon intensity of the synthetic fuel produced has been demonstrated through an example as shown in Table 1. For simplicity, it's been assumed that the fuel and electricity demand of the synthetic fuel production system are the primary contributors to direct and indirect emissions of the system. Emissions resulting from combustion of fuel used in oxy-fired equipment in the system account for direct emissions, while emissions associated with production, recovery or transportation/distribution of fuel/electricity account for indirect emissions. It's been assumed that for each Mega Joule (MJ) of synthetic fuel produced, the oxy-combustion process(es) in the synthetic fuel production system utilize 0.4 MJ of energy, and 0.6 KWh electricity is used for other operations in the system.

The values in Table 1 clearly indicate that while electricity generation in coal-fired plants is carbon intensive and significantly increases the carbon intensity of the synthetic fuel, using renewables, such as hydroelectricity, solar and wind can significantly reduce the carbon intensity of the fuel, in some cases to below 10 g CO₂ e/MJ fuel.

TABLE 1
A case study to show the impact of burner fuel type and source
of electricity on the carbon intensity of the synthetic fuel

| | Source of fuel for oxy-combustion + | | | | |
|---|---|---|---|---|---|
| | Source of electricity | | | | |
| GHG emissions | | | | 4: A11 | 5: All |
| (g CO₂e/MJ | 1: NG + | 2: NG + | 3: H₂ + | electric | electric |
| synthetic fuel) | Coal | hydro | hydro | (hydro) | (solar) |
| Production and | 3 | 3 | 0 | 0 | 0 |
| transportation | | | | | |
| of burner fuel | | | | | |
| Generation and | 490 | 6 | 8.5 | 8 | 4 |
| distribution | | | | | |
| of electricity | | | | | |
| Total emissions | 493 | 9 | 8.5 | 8 | 4 |

The carbon intensities of alternative biodiesels are in the range of 30-70 g CO₂ e/MJ biodiesel, and as high as 90-100 g CO₂ e/MJ for conventional gasoline and diesel. Synthetic fuels produced as described herein can have a carbon intensity that is less than half that of typical biofuels, meaning that these synthetic fuels get high revenues from market-based emissions programs.

Synthetic fuels, for example the diesel and gasoline products, are drop-in compatible with current infrastructure and engines, and can have up to about 30 times higher energy density than batteries, as well as up to about 100 times lower land/water use impact than biofuels. Because of the selection of commercially available equipment for most if not all units described within the synthetic fuel system, these systems can be highly scalable, and thus applicable to a range of markets, including the transportation fuel market.

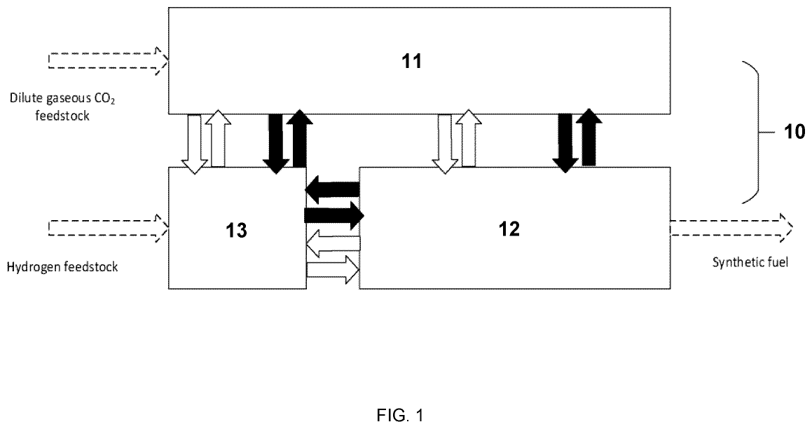

Referring to FIG. 1, the example system 10 shown in FIG. 1 includes three subsystems, namely, a CO₂ capture subsystem 11 (also referred to herein as a “Direct Air Capture system” or “DAC system”) for extracting CO₂ molecules from a CO₂ feedstock, a hydrogen production subsystem 13 for extracting hydrogen molecules from a hydrogen feedstock, and a hydrocarbon production subsystem 12 for producing synfuel using the hydrogen molecules produced by the hydrogen production subsystem 13 and the carbon from the CO₂ molecules produced by the CO₂ capture subsystem 11. Reference is made to U.S. patent application Ser. No. 16/472,379 entitled “Method and system for synthesizing fuel from dilute carbon dioxide source”, the entirety of which is incorporated by reference herein.

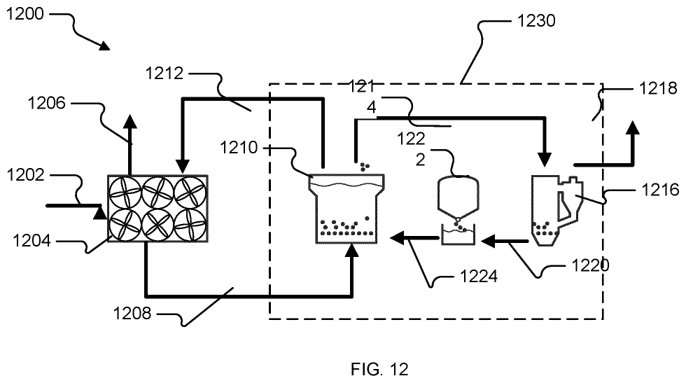

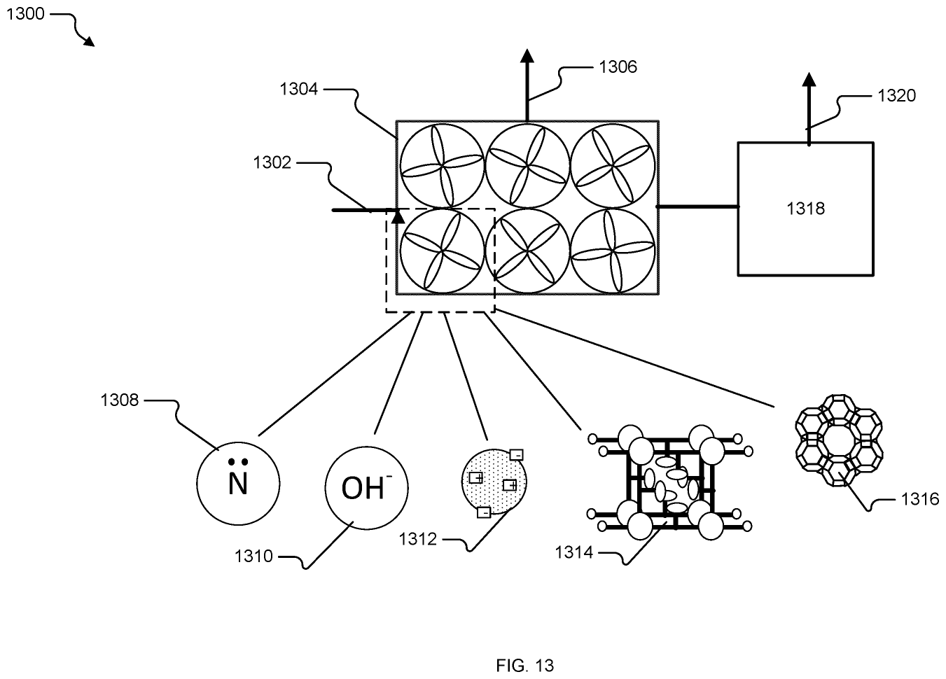

Referring to FIG. 1, the CO₂ capture subsystem 11 extracts CO₂ from dilute sources, such as atmospheric air, and may include equipment such as air contactors, gas-liquid contactors, or gas-liquid contactors in the form of gas scrubbers, spray towers, or any other design wherein gas is contacted with the capture solution or a sorbent. As used herein “sorbent” refers to the material that undergoes sorption of a target species. As used herein, “sorption” refers to a process, physical, chemical or a combination of both, by which one substance becomes attached to another for some period of time. Examples of specific categories of sorption may include adsorption (physical adherence or bonding of ions and/or molecules onto the surface of another material), absorption (the incorporation of a substance in one state-gas, liquid, solid-into another substance of a different state) and ion exchange (exchange of ions between electrolytes or between an electrolyte solution and a complex). The CO₂ capture subsystem 11 can operate with a liquid sorbent (also referred to herein as a “CO₂ capture solution”), as described in greater detail below in reference to FIG. 12. In some implementations, the CO₂ capture subsystem 11 can operate with a solid sorbent, as described in greater detail below in reference to FIG. 13.

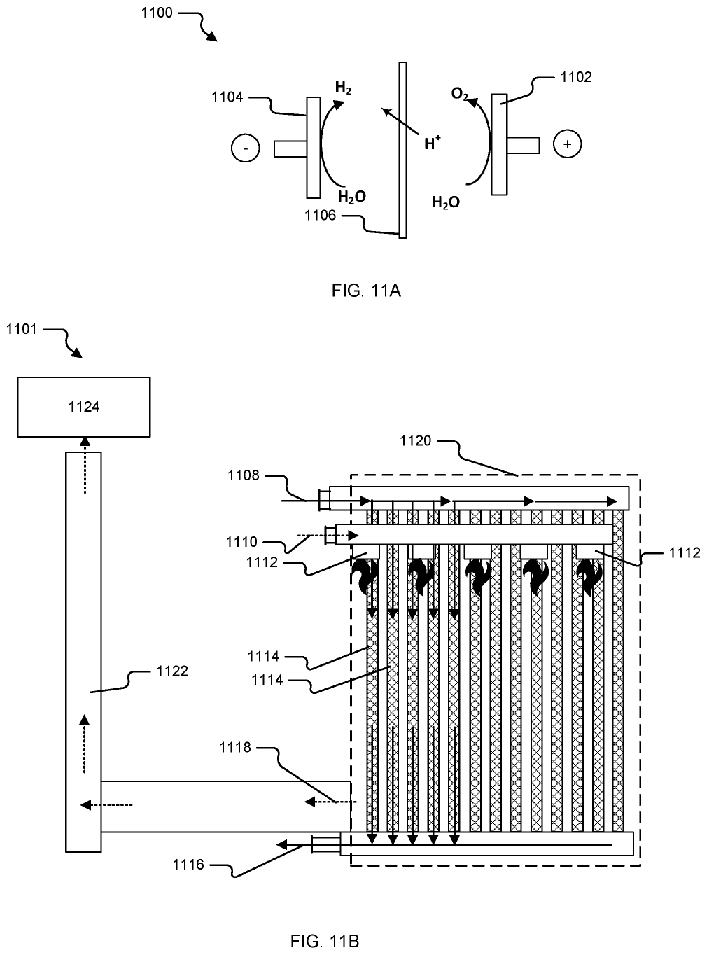

The hydrogen production subsystem 13 produces hydrogen molecules from a hydrogen-containing feedstock. The hydrogen-containing feedstock can include hydrogen compounds such as water, methane, or short-chain hydrocarbons and is typically in a fluid state. In some implementations, hydrogen can be produced using electrolysis in a water electrolyzer that applies an electric potential to an electrolyte to extract hydrogen molecules, as described in greater detail below in reference to FIG. 11A. A number of hydrogen production pathways exist for electrolysis, such as alkaline electrolysis, proton exchange membrane (also known as a polymer electrolyte membrane (PEM)), electrolysis hydrogen production and fuel cell technologies, and solid oxide electrolysis cell (SOEC) electrolysis. In some implementations, hydrogen can be produced by steam-methane reforming of a methane-containing feedstock or a combustible gas, as described in greater detail below in reference to FIG. 11B. Steam-methane reforming employs a reaction of methane with water via an endothermic reaction in a reformer unit to produce hydrogen, carbon monoxide, and CO₂. The CO₂ product can be captured via the CO₂ capture subsystem 11 and processed downstream for uses like producing synthetic fuels, sequestration, or enhanced oil recovery.

The hydrocarbon production subsystem 12 produces synthetic fuels from hydrogen produced by the hydrogen production subsystem 13 and carbon from the CO₂ that was extracted from atmospheric air by the CO₂ capture subsystem 11. As used herein, “synthetic fuel” includes high quality petroleum products, such as transportation fuels or petroleum chemicals. The terms “synthetic fuel,” “fuel synthesis products,” “Fischer-Tropsch (FT) fuels,” “synfuels,” and “solar fuels” are used interchangeably in the present disclosure.

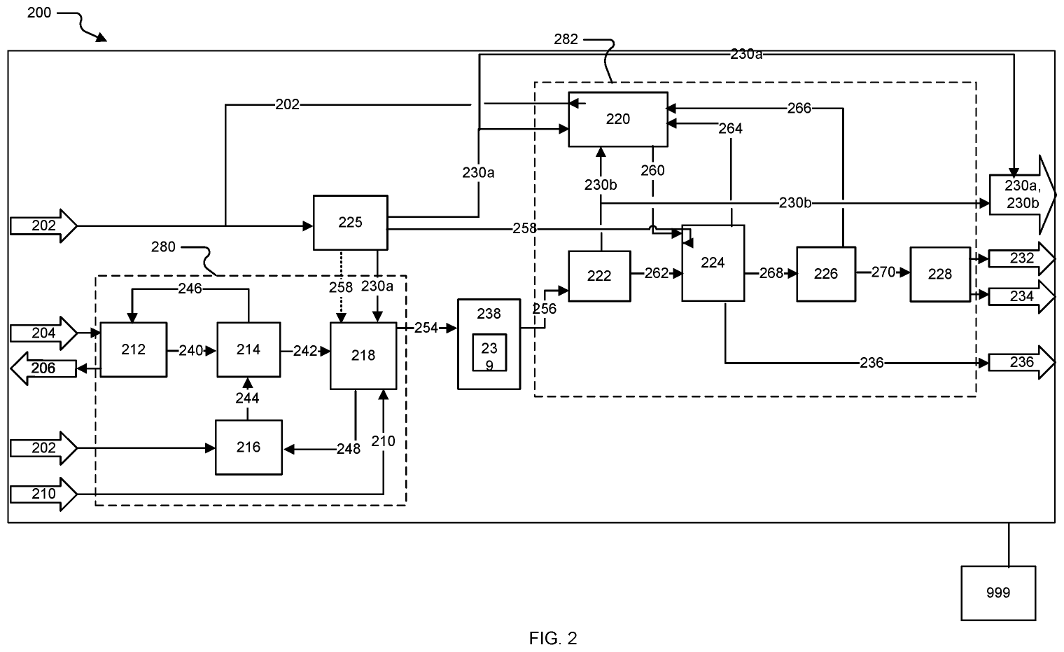

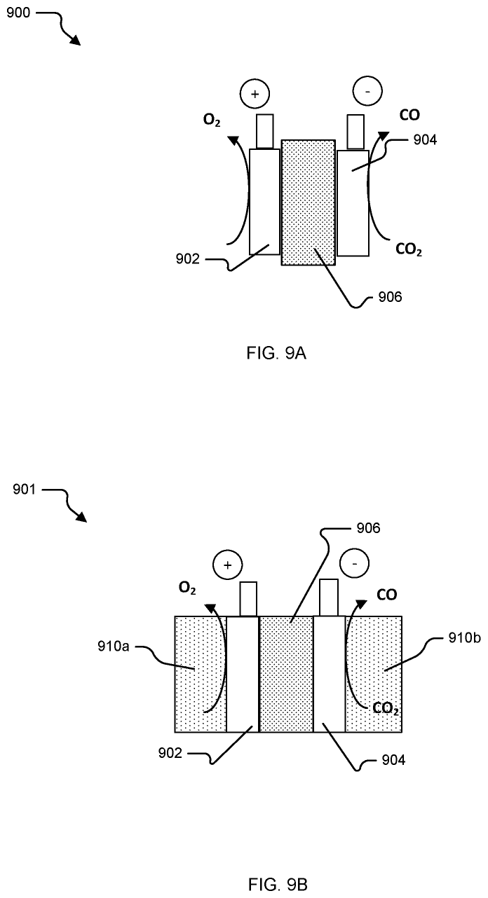

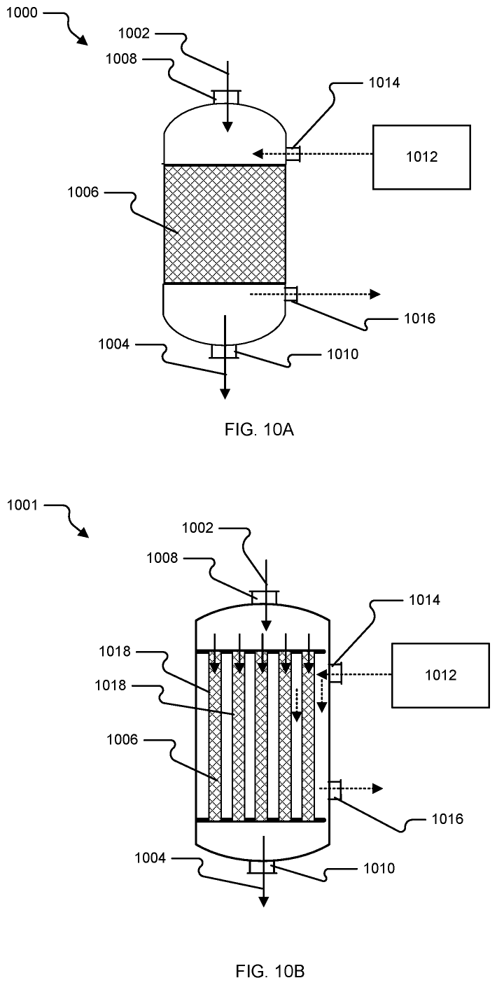

The hydrocarbon production subsystem 12 utilizes fuel synthesis techniques (also referred to herein as “pathways”) that involve reacting hydrogen with carbon that is sourced from CO₂ in atmospheric air, with the atmospheric air in this configuration being a carbon-containing feedstock. Some pathways use intermediates such as syngas (a mixture of carbon monoxide (CO) and hydrogen (H₂) to produce “Fischer Tropsch (FT) crude” which is similar in composition to light crude oil. As used herein, syngas refers to a mixture of CO and H₂ gases but may possibly contain small amounts of CO₂, methane, and water vapor, and other trace gases. The hydrocarbon production subsystem 12 includes a CO₂ reduction reactor, which can be electrocatalytic or thermocatalytic, to produce CO from recovered CO₂ that was extracted from atmospheric air. The CO₂ reduction reactors are described in greater detail below, in reference to FIG. 9A through FIG. 10B. The FT crude can be refined to deliver final marketable synthetic fuels such as synthetic natural gas, liquefied petroleum gas (LPGs), gasoline, jet fuel, aviation turbine fuel, or diesel. In the refining steps, a refined tail gas and a refined crude is produced. It can be beneficial to use the refined tail gas and the refined crude as a reactant or for generating thermal energy in other units of system 10 where possible. The hydrocarbon production subsystem 12 is fluidly coupled to the CO₂ capture subsystem 11, and in some configurations disclosed herein, is also fluidly coupled to the hydrogen production subsystem 13 to produce the synthetic fuels, as described in greater detail below in reference to FIG. 2 through FIG. 5. In some cases, hydrogen can be provided to the hydrocarbon production subsystem 12 through another source outside of the hydrogen production subsystem 13 (e.g., a hydrogen pipeline).

In some cases, it can be beneficial to remove water from a particular process stream to reduce the impact of water on downstream units or increase the concentration or purity of the process stream. Removing water from a stream can be achieved via a chemical or physical approach, or a combination of these approaches. An example chemical approach for removing water is interfacing the gaseous stream (e.g., syngas product stream, calciner product gas) with a material that can react with the water, for example CaO, to form another product such as Ca(OH)₂, or some type of desiccant. Another example chemical approach for removing water is splitting the water into H₂ and O₂ as part of a hydrogen production unit. Example physical approaches for extracting water include cooling, condensation, filtration, or membrane separation. A water conduit serves as a form of product conduit that includes water, such as steam, and may include additional gaseous species, such as, CO, H₂, CO₂ and O₂. The transfer of material produced in one subsystem to another subsystem or between units within a subsystem can serve as material transfer coupling. Examples of material transfer coupling include transfer of material through a water conduit, an oxidant conduit or a fuel conduit.

While the implementation of the hydrocarbon production subsystem 12 shown in FIG. 1 uses a pathway for synthesizing fuels from CO₂ that involves generating a syngas, the hydrocarbon production subsystem 12 can synthesize fuels using other pathways, including pathways that synthesize fuels from CO₂ using renewable or low carbon energy sources, for example solar, wind, hydro, geothermal, nuclear, or a combination of these components. Many of these pathways also utilize syngas as an intermediate component. However, synthetic fuel can also be created using methanol synthesis from syngas followed by methanol-to-gasoline (MTG) conversion. The MTG process uses a zeolite catalyst at around 400° C. and 10-15 bar. Methanol is first converted to di-methyl ether (DME), and then on to a blend of light olefins. These, in turn, are reacted to produce a blend of hydrocarbon molecules.

The hydrocarbon production subsystem 12 can also use a pathway wherein synthetic fuel is created using a methanol-to-olefins (MTO) process, which is similar to the MTG process but is optimized to first produce olefins. These are then fed into another zeolite catalyst process, like Mobil's olefin-to-gasoline and distillate process (MOGD), to produce gasoline. As used herein, the acronym “MTO” refers to the combination of MTO and MOGD. MTG and MTO produce tighter distributions of carbon chain length than Fischer-Tropsch, due to their more selective catalysts. This selectivity reduces the need for post-processing/upgrading and may make for more energy efficient conversion pathways.

The hydrocarbon production subsystem 12 can also use a pathway wherein synthetic fuel is created by direct hydrogenation. Here, methanol is synthesized directly from CO₂ and hydrogen followed by MTG conversion. Where methanol synthesis processes are used, synthetic fuel can then be produced using processes such as methanol-to-gasoline (MTG) or methanol-to-olefins (MTO). In still further implementations, the carbon dioxide from dilute source capture can be fed directly to a hydrogenation process, combined with hydrogen, and then fed into methanol-based fuel synthesis processes. The above examples are illustrative, rather than prescriptive, examples of implementations of the air to fuels processes described herein.

Table 2 illustrates some example chemical reactions that can occur in CO₂ capture processes, H₂ production processes, and hydrocarbon production processes along with approximate heats of reaction. These pathways suggest how heat energy and/or materials can be exchanged between the subsystems 11, 12 and 13 that perform these processes.

TABLE 2
Chemical Reactions and Approximate Heats Associated with Air to Fuels Processes

| | Location of | | Approximate |
|---|---|---|---|
| | Reaction in the | | ΔH (kJ/mol |
| Process | Process | Chemical Reaction(s) | product) |
| CO₂ Capture | Air contactor; | CO₂(g) + 2KOH(aq) → K₂CO₃(aq) + H₂O(l); | −96; |
| | Pellet reactor; | K₂CO₃(aq) + Ca(OH)₂(aq) → 2KOH(aq) + | −6; |
| | | CaCO₃(s); | |
| CO₂ Capture | Calciner | CH₄(g) + O₂(g) → 2H₂O(g) + CO₂(g); | −165; |
| (Oxy-fired | | CaCO₃(s) + Heat ← → CaO(s) + CO₂(g); | +165; |
| Calcination) | | | |
| CO₂ Capture | Lime Hydrator, | CaO(s) + H₂O(g/l) → Ca(OH)₂(s); | −64; |
| (Lime Slaking | paste slaker or | | |
| or Hydration) | steam slaker | | |
| H₂ Production | Water | 2H₂O(l) + electricity → H₂(g) + O₂(g); | +286; |
| | electrolyzer | 2H₂O(g) + electricity → H₂(g) + O₂(g); | +242; |
| Syngas | Steam | CH₄(g) + H₂O(g) ← → CO(g) + 3H₂(g); | +206; |
| Production | Methane | | |
| | Reformer | | |
| Syngas | Partial | CH₄(g) + ½O₂(g) ←→ CO(g) + 2H₂(g); | −36; |
| Production | Oxidation | | |
| | Reformer | | |
| Syngas | Dry Methane | CH₄(g) + CO₂(g) ←→ 2CO(g) + 2H₂(g); | +247; |
| Production | Reformer | | |
| Syngas | Autothermal | CH₄(g) + ½xO2(g) + yCO₂(g) + (1-x-y)H₂O(g) | ~0; |
| Production | Reformer | ←→ (y + 1)CO(g) + (3-x-y)H₂(g); | |
| Syngas | Electrocatalytic | 2CO₂(g) + electricity ← → 2CO(g) + O₂(g) | +283; |
| Production | CO₂ reduction | | |
| | reactor | | |
| Syngas | Thermocatalytic | H₂(g) + CO₂(g) ←→ CO(g) + H₂O(g); | +41; |
| Production | CO₂ reduction | CO₂(g) + 4H₂(g) ←→ CH₄(g) + 2H₂O(g); | −165; |
| | reactor | CO(g) + 3H₂(g) ←→ CH₄(g) + H₂O(g); | −206; |
| Syngas | Syngas unit | CH₄(g) ←→ C(s) + 2H₂(g); | +75; |
| Production | | 2CO(g) ← → C(s) + CO₂(g); | −172; |
| | | CO₂(g) + 2H₂(g) ← → C(s) + 2H₂O(g); | −90; |
| | | H₂(g) + CO(g) ← → H₂O(g) + C(s); | −131; |
| Synthetic Fuel | Fischer- | CO(g) + 2H₂(g) ←→ (—CH₂—) + H₂O(g); | −152; |
| Production | Tropsch Unit | | |
| Synthetic Fuel | Methanol | CO(g) + 2H₂(g) ←→ CH₃OH(l); | −91; |
| Production | Production unit | CO₂(g) + 3H₂(g) ←→ CH₃OH(l) + H₂O(l); | −49; |
| Synthetic Fuel | Methanol-to- | 2CH₃OH(l) ← → CH₃OCH₃ + H₂O; | −37; |
| Production | Gasoline unit | | |
| Synthetic Fuel | Methanol-to- | 2CH₃OH(l) ← → CH₃OCH₃ + H₂O; | −37; |
| Production | Olefin unit | | |

At least some of the energy (shown as black arrows in FIG. 1) and/or at least some of the fluids (shown as white arrows in FIG. 1) used by one subsystem can be obtained from another subsystem. In some implementations, water produced by the CO₂ capture subsystem 11 and/or by the hydrocarbon production subsystem 12 is used as the hydrogen feedstock by the hydrogen production subsystem 13. In some implementations, heat energy produced by the CO₂ capture subsystem 11 is used in a process in the hydrocarbon production subsystem 12 or in the hydrogen production subsystem 13. In some implementations, heat energy produced by the hydrocarbon production subsystem 12 is used to preheat a material stream flowing through the CO₂ capture subsystem 11. In some implementations, reactions occurring within the CO₂ capture subsystem 11 are used to remove water from a material stream in the hydrocarbon production subsystem 12. In some implementations, heat and oxygen produced by the hydrogen production subsystem 13 are used in a combustion process within the hydrocarbon production subsystem 12 and/or CO₂ capture subsystem 11.

In each of these implementations, it is expected that one or more of the cost effectiveness, operational efficiency, and operational flexibility of the overall system can be improved by having one subsystem use energy and/or fluids produced by another subsystem, rather than obtaining the energy and/or fluids from an external source. Also, the system can be used in applications where it may be challenging to provide an external source of such energy and/or fluids, such as a location where water is scarce. Furthermore, the system can potentially reduce the carbon intensity of the produced synfuel as compared to conventional fossil fuels.

As noted above, the heat energy from one subsystem 11, 12, 13 can be used as input energy by another subsystem 11, 12, 13. The hydrocarbon production subsystem 12 can generate medium grade heat while performing fuel synthesis (e.g., Fischer Tropsch ˜250-350° C.), which can be used by various machines in the system 10. For example, the hydrocarbon production subsystem 12 may include a CO₂ reduction reactor that preheats boiler feedwater and a Fischer-Tropsch reactor that preheats a reactor feed stream. The CO₂ capture subsystem 11 can also generate high grade heat (e.g., Calciner-˜850-950° C.) that can be used in other process units. For example, the CO₂ capture subsystem 11 can include a calciner to preheat feed streams and a slaker to produce steam in slaking reactions. This medium and high-grade heat can also be used to generate power, as well as to provide steam heat for downstream refining and distillation systems.

Similarly, fluids produced or discharged by one subsystem 11, 12, 13 can be used as feedstock or for other processes in another subsystem. For example, the hydrocarbon production subsystem 12 generates steam (e.g., by a CO₂ reduction reactor and a Fischer-Tropsch reactor) and the CO₂ capture subsystem 11 generates water (e.g., by combustion reaction in a calciner), which can be used by various machines in the system 10. For example, water produced by one or more of the subsystems 11, 12, 13 can be used to replace water loss due to evaporation, to produce process materials like slaked lime, to wash pellets to remove alkali content, to regenerate sorbent and release CO₂ in a sorbent regeneration unit, to serve as hydrogen feedstock in the hydrogen production subsystem 13, or a combination thereof.

FIG. 2 is a schematic diagram of an example system 200 for producing synthetic fuels from CO₂ in atmospheric air 204. System 200 employs an electrocatalytic CO₂ reduction reactor 222 and an autothermal reformer (ATR) 220. In some cases, system 200 can produce synthetic fuels from CO₂ sourced from a gas mixture other than atmospheric air, where the other gas mixture has less than about 1 vol % CO₂ content. The system 200 includes a CO₂ capture subsystem 280, a hydrogen production subsystem 225, and a hydrocarbon production subsystem 282 that are fluidly coupled to one another. The CO₂ capture subsystem 280 extracts CO₂ from the atmospheric air 204, concentrates the CO₂, and produces a recovered CO₂ stream 254 that is used in a downstream hydrocarbon production subsystem for fuel synthesis. The hydrogen production subsystem 225 extracts hydrogen molecules from a hydrogen feedstock 202 for hydrocarbon synthesis. In some implementations, the hydrocarbon production subsystem 282 can be fluidly coupled to a hydrogen source (e.g., hydrogen pipeline) instead of or in addition to the hydrogen production subsystem 225. The hydrocarbon production subsystem 282 produces synthetic fuels using the hydrogen 258 produced by the hydrogen production subsystem 225 and the recovered CO₂ 254 produced by the CO₂ capture subsystem 280.

Referring to FIG. 2, the CO₂ capture subsystem 280 includes an air contactor 212 that employs a CO₂ capture solution 246 as a sorbent material to capture CO₂ from atmospheric air. Non-limiting examples of CO₂ capture solutions include aqueous alkaline solutions (e.g., KOH, NaOH, or a combination thereof), aqueous amino acid salt solutions, non-aqueous solutions of amines, aqueous carbonate and/or bicarbonate solutions, phenoxides/phenoxide salts, ionic liquids, non-aqueous solvents, or a combination thereof. In some cases, the CO₂ capture solution 246 may include promoters and/or additives that increase the rate of CO₂ uptake. Non-limiting examples of promoters include carbonic anhydrase, amines (primary, secondary, tertiary), and boric acid. Non-limiting examples of additives include chlorides, sulfates, acetates, phosphates, surfactants.

Referring to FIG. 2, the CO₂ capture solution 246 includes an aqueous alkaline solution to capture CO₂ from atmospheric air. To regenerate the CO₂ capture solution 246 and to recover the CO₂ for downstream use, the CO₂ capture subsystem 280 has a regeneration system including a pellet reactor 214, a slaker 216, and a calciner 218. In this example, inputs to the air contactor 212 include air 204 (e.g., atmospheric, outside air) and the CO₂ capture solution 246 from the pellet reactor 214. The CO₂ capture solution 246 may be rich in hydroxide (e.g., KOH-rich). Outputs from the air contactor 212 include a CO₂-laden solution 240 that flows to the pellet reactor 214 and CO₂-lean air 206 that has lower CO₂ concentration than the air stream 204. The CO₂-laden solution 240 may be rich in carbonate (e.g., K2CO3). In this example, inputs to the pellet reactor 214 include that CO₂-laden solution 240 from the air contactor 212 and a calcium hydroxide (Ca(OH)₂) stream 244 from the slaker 216. Outputs from the pellet reactor 214 include a calcium carbonate (CaCO₃) stream 242 that flows to the calciner 218 and the CO₂ capture 20) solution 246 that flows to the air contactor 212. In this example, inputs to the slaker 216 include a water stream 202 and a calcium oxide (CaO) stream 248 from the calciner 218. Outputs from the slaker 216 include the calcium hydroxide (Ca(OH)₂) stream 244 that flows to the pellet reactor 214. In this example of the system 200, inputs to the calciner 218 include a natural gas stream 210, an oxygen (O₂) stream 230a from the hydrogen production subsystem 225, CaCO₃ 242 from the pellet reactor 214, and, optionally, a hydrogen (H₂) fuel stream 258 from the hydrogen production subsystem 225. Outputs from the calciner 218 include CaO 248, which is provided to the slaker 216, and a recovered CO₂ stream 254. In some cases, the oxygen stream 230a is an electrolyzer oxygen stream produced by a water electrolyzer.

In some implementations, the CO₂ capture subsystem 280 may include multiple air contactors 212, multiple pellet reactors 214, and/or multiple slakers 216 to form a train/assembly of the respective units. The operation and reactions that occur in the illustrated implementation of the CO₂ capture subsystem 280 are described in greater detail below, for example in reference to FIG. 12. In some implementations, the air contactor 212 of CO₂ capture subsystem 280 can include or employ a different sorbent to capture CO₂ from atmospheric air and/or different regeneration units to recover the CO₂ as the recovered CO₂ stream 254. Other configurations of the CO₂ capture subsystem 280 are possible. Some example embodiments of alternative CO₂ capture subsystems 280 are described in greater detail below.

Although each of the aforementioned units are schematically illustrated as being an element of the CO₂ capture subsystem 280 in FIG. 2, in some aspects, each unit is independent and can be positioned relatively near or relatively far from another unit. For example, it may be beneficial to position the calciner 218 near a particular unit that is a constituent of the hydrocarbon production subsystem 282. In some aspects, synergies and unexpected results can result from positioning certain components or units relatively near to each other, as smaller distances between units can reduce energy requirements for gas compression and reduce friction or heat losses of flowing heat exchange media (e.g., stream, cooling water systems, etc.). In some implementations, a component or unit is relatively near another component or unit if the distance between them is about 250 meters or less. The reduction in energy requirements and losses can lower operating costs significantly.

In some implementations, an example of which is shown in FIG. 2, the recovered CO₂ stream 254 is sent to a CO₂ purification and compression unit 238 prior to flowing to the hydrocarbon production subsystem 282. In some aspects, the one or more CO₂ purification and compression units 238 may be located inside the battery limit of the CO₂ capture subsystem 280, within an auxiliary process area, between the CO₂ capture subsystem 280 and the hydrocarbon production subsystem 282, or within the battery limit of the hydrocarbon production subsystem 282. The battery limit is the boundary defining the area in which the units of a particular system are located. In the illustrated implementation, the CO₂ purification and compression unit 238 can receive the recovered CO₂ stream 254 from the CO₂ capture subsystem 280. The CO₂ purification and compression unit 238 functions to remove at least a portion of impurities from the recovered CO₂ stream 254 to achieve a recovered CO₂ feed stream 256 that is substantially free of contaminants. In some cases, the recovered CO₂ feed stream is at least 99 wt % CO₂. Examples of impurities may include oxygen, inert gases (such as nitrogen and argon), water vapor, or a combination thereof. In some cases, water vapor that is removed from the recovered CO₂ feed stream 254 by the CO₂ purification and compression unit 238 can be sent to a water treatment facility or to another unit that requires water as an input stream. The CO₂ purification and compression unit 238 can include a pressure swing absorber, a cryogenic distillation unit, a membrane separation unit, a single- or multiple-stage compression train and water knockout, or a combination thereof. The recovered CO₂ feed stream 256 is sent to the hydrocarbon production subsystem 282.

Hydrogen is required to produce a synthetic fuel according to the present disclosure. In the illustrated implementation, the hydrogen production subsystem 225 includes, or is, a water electrolyzer that electrolyzes water 202 to form electrolyzer oxygen 230a (referred to herein as “oxygen stream 230a” for brevity) and a hydrogen stream 258. At least some of the oxygen stream 230a can be sent to the calciner 218 for generating thermal energy for calcination via oxy-combustion. In another possible implementation, the hydrogen production subsystem 225 includes, or is, a steam-methane reformer that reacts methane CH₄ with water in an endothermic reaction to produce syngas, and employs a water gas shift reaction to produce primarily hydrogen 258. Example embodiments of the hydrogen production subsystem 225 are described in greater detail below, in reference to FIG. 11A and FIG. 11B. In the illustrated implementation, at least a portion of the oxygen 230a and the hydrogen 258 produced by the water electrolyzer of the hydrogen production subsystem 225 is sent to the hydrocarbon production subsystem 282. Some of the oxygen 230a from the water electrolyzer is compressed and sent to autothermal reformer 220. In some implementations, water 202 includes, or is, a steam stream that is fed to the water electrolyzer or other units in system 200.

In the illustrated implementation, the CO₂ capture subsystem 280 includes a calciner 218 and the hydrogen production subsystem 225 includes a water electrolyzer. In some examples, the water electrolyzer can include a polymer electrolyte membrane (PEM) or solid oxide electrolysis cell (SOEC). In some aspects, the system 200 can utilize the oxygen O₂ stream 230a from the water electrolyzer for oxy-firing the calciner 218. For example, the oxygen 230a from the water electrolyzer can be compressed to be used as a feed stream for the calciner 218. In some aspects, the CO₂ capture subsystem 280 and the calciner 218, which may be oxy-fired, can operate more efficiently by using substantially pure oxygen for combustion that is obtained from the water electrolyzer.

In some aspects, the system 200 can utilize partial or full displacement of natural gas 210 with an H₂ or H₂-mixture as fuel for the calciner 218. A portion of hydrogen 258 from the hydrogen production subsystem 225 can be used to provide thermal energy by reaction with oxygen 230a in the calciner 218. For example, a portion of hydrogen 258 may be blended with natural gas 210 and combusted with oxygen 230a in the calciner 218 to generate heat for the calcination reaction. For example, a stream of only hydrogen 258 may be oxidized in the calciner 218 to generate heat. The requirements for natural gas 210 can be reduced or eliminated by using hydrogen 258 to fuel the calciner 218, which can reduce the overall carbon intensity of system 200.

In the system 200 shown in FIG. 2, the hydrocarbon production subsystem 282 includes an electrocatalytic CO₂ reduction reactor 222, an autothermal reformer 220, a Fischer-Tropsch (FT) reactor 224, refining units 226, and a distillation unit 228 that are fluidly coupled to one another. Similar to the units of the CO₂ capture subsystem of 280, the aforementioned units are schematically illustrated as being an element of the hydrocarbon production subsystem 282, but may benefit from being positioned relatively near another unit to reduce energy requirements and frictional or heat losses, thereby lowering operating costs.

Carbon monoxide (CO) is an essential reactant in the hydrocarbon production subsystem, as it provides the carbon atoms needed to form hydrocarbons that make up synthetic fuel. Commercially available FT reactors are not amenable to converting CO₂ directly into hydrocarbons and thereby necessitate that CO₂ first be converted into molecules that can be polymerized, such as CO. Some electrocatalytic CO₂ reduction reactors operate at high temperatures to function efficiently. Unlike conventional approaches for forming CO and/or syngas from CO₂, electrochemical approaches that implement electrocatalytic reactors are powered electrically and are free of a burner, and therefore avoid the need for combusting fossil fuels to heat the reactor to its operating temperature. Thus, the carbon intensity of electrocatalytic CO₂ reduction reactors can be lower than that of conventional reactors that require combustion.

The electrocatalytic CO₂ reduction reactor 222 receives the recovered CO₂ feed stream 256 from the CO₂ capture subsystem 280. The electrocatalytic CO₂ reduction reactor 222 produces carbon monoxide (CO) 262 and oxygen 230b by performing an electrochemical reduction reaction on the CO₂ in the recovered CO₂ feed stream 256 (CO₂—CO+1/2O₂) over a catalyst. In some cases, the electrocatalytic CO₂ reduction reactor 222 can employ one or more of the reactions described in Table 2 (see reactions listed for the electrocatalytic CO₂ reduction reactor). In some implementations, the electrocatalytic CO₂ reduction reactor 222 can include a solid oxide electrolysis cell, a molten carbonate electrolysis cell, a polymer electrolyte membrane fuel cell, a low-temperature electrolysis cell, or a combination thereof. Some possible configurations of the electrocatalytic CO₂ reduction reactor 222 are described in greater detail below in reference to FIG. 9A and FIG. 9B. The oxygen 230b produced by the electrocatalytic CO₂ reduction reactor 222 can be used in the autothermal reformer 220, which can reduce or eliminate the requirement for other oxygen sources, such as an air separation unit (ASU). In some aspects, the system 200 can utilize the oxygen O₂ stream 230a from the water electrolyzer and/or from the CO₂ reduction reactor 222 to be used for oxy-firing the calciner 218.

Referring to FIG. 2, the FT reactor 224 receives the CO stream 262 from the electrocatalytic CO₂ reduction reactor 222 and the hydrogen stream 258 from the hydrogen production subsystem 225. The FT reactor 224 also receives a syngas 260 (consisting primarily of CO and hydrogen) from the ATR 220. The FT reactor 224 reacts the hydrogen and CO in the feed streams in polymerization reactions (also referred to as “FT synthesis”) to form an FT tail gas 264 and an FT crude 268 stream, which in combination, include a multicomponent mixture of linear and branched hydrocarbons and oxygenated products, ranging across gases, liquids and waxes. In some implementations, the FT reactor 224 may operate between 200° C. to 350° C. and from 10 bar to 60 bar. The FT synthesis process produces a combination of light end hydrocarbons and heavy end hydrocarbons, which are defined below. In some aspects, a portion of the FT tail gas 264 and FT crude 268 may have low aromaticity and low to zero sulfur content. Products of the FT reactor 224 may also include linear paraffins and olefins, namely: hydrogen and low molecular weight hydrocarbons (C1-C4), medium molecular weight hydrocarbons (C4-C13) and high molecular weight hydrocarbons (C13+). Hydrogen and low molecular weight hydrocarbons can be used to make combustion fuels, polymers, and fine chemicals. Medium molecular weight hydrocarbons having for example similar compositions to gasoline can be used as feedstock for lubricants and diesel fuels. High molecular weight hydrocarbons are waxes or paraffins and can be feedstocks for lubricants and can also be further refined or hydrocracked to diesel fuel.

Generally, an FT tail gas stream 264 constitutes mainly light end hydrocarbons and an FT crude stream 268 constitutes mainly heavy end hydrocarbons. The FT reactor 224 can also produce water 236 as a product of the FT synthesis reactions. Some or all of the water 236 can be treated in a water treatment facility and/or recycled for us in other units within system 200.

Light end hydrocarbons may be considered as hydrocarbons that exist in gas phase under standard ambient temperature and pressure. Light end hydrocarbons typically include short-chain hydrocarbons (C1-C4) that have a relatively low molecular weight. For example, methane, butane, and propane are considered light end hydrocarbons. In some cases, a gaseous synthetic fuel stream that contains light end hydrocarbons may also include hydrogen. The hydrogen may be separated using a membrane and recycled separately as feedstock to other units, for example to the FT reactor 224. After refining, some synthetic fuel products that can be formed from light end hydrocarbons include synthetic natural gas and liquefied petroleum gas (LPGs).

The FT reactor 224 also produces heavy end hydrocarbons. Heavy end hydrocarbons may be considered hydrocarbons that exist in liquid (e.g., naphtha, distillates) or solid (e.g., wax) phase under standard ambient temperature and pressure. Heavy hydrocarbons typically include medium-chain hydrocarbons (C4-C13) that have a medium molecular weight and long-chain hydrocarbons (C13+) that have a high molecular weight. After refining, some synthetic fuel products that can be formed from heavy end hydrocarbons include gasoline, diesel, jet fuel, aviation turbine fuel, and waxes. The Fischer Tropsch fuel synthesis products described herein may be further refined into specific fuel types that meet the requirements of certain fuel standards (e.g., standard specifications for fuels dictated by the ASTM). In some cases, the synthetic fuels may be further refined into petrochemicals or petroleum products such as plastics or polymers.

Referring to FIG. 2, the FT tail gas 264 includes mainly gaseous light end hydrocarbons (C1-C4) which can be a useful input for units that require combustion or oxidation to execute reactions. One such unit is the ATR 220. The ATR 220 includes a vessel that encloses a burner, a combustion chamber and a catalytic reaction zone. The ATR 220 can include at least one inlet that receives a combustible gas, oxygen 230, and steam 202. The combustible gas can be a methane-containing feedstock such as the FT tail gas 264. The combustible gas can be preheated by mixing with the steam 202 and the oxygen in the burner, and the reaction can be initiated in the combustion chamber of the ATR 220. The catalytic reaction zone can include a catalyst bed supporting a nickel-containing catalyst that converts reactants into syngas.

In the illustrated implementation, the ATR 220 functions to convert the FT tail gas 264 and a refined tail gas 266 into syngas 260. The ATR 220 receives the FT tail gas 264, steam 202, and oxygen streams 230a, 230b. In some implementation, as depicted in FIG. 2, the ATR 220 receives the oxygen streams 230a, 230b from both the electrocatalytic CO₂ reduction unit 222 and the hydrogen production subsystem 225. In some cases, the ATR 220 may receive oxygen 230 from only one of the electrocatalytic CO₂ reduction unit 222 or the hydrogen production subsystem 225. The ATR 220 oxidizes the FT tail gas 264 with the oxygen 230a, 230b in the presence of steam 202 to produce the syngas 260 for FT synthesis in the FT reactor 224 via the reforming and shift reactions described in Table 2. In some implementations, other light end components of the FT tail gas 264 may be partially converted into methane in the combustion chamber of the ATR 220 and then reformed into syngas 260 in the catalytic reaction zone of the ATR 220. The syngas 260 can be sent to the FT reactor 224 to produce FT crude 268 and FT tail gas 264, thereby closing the FT tail gas recycle loop.

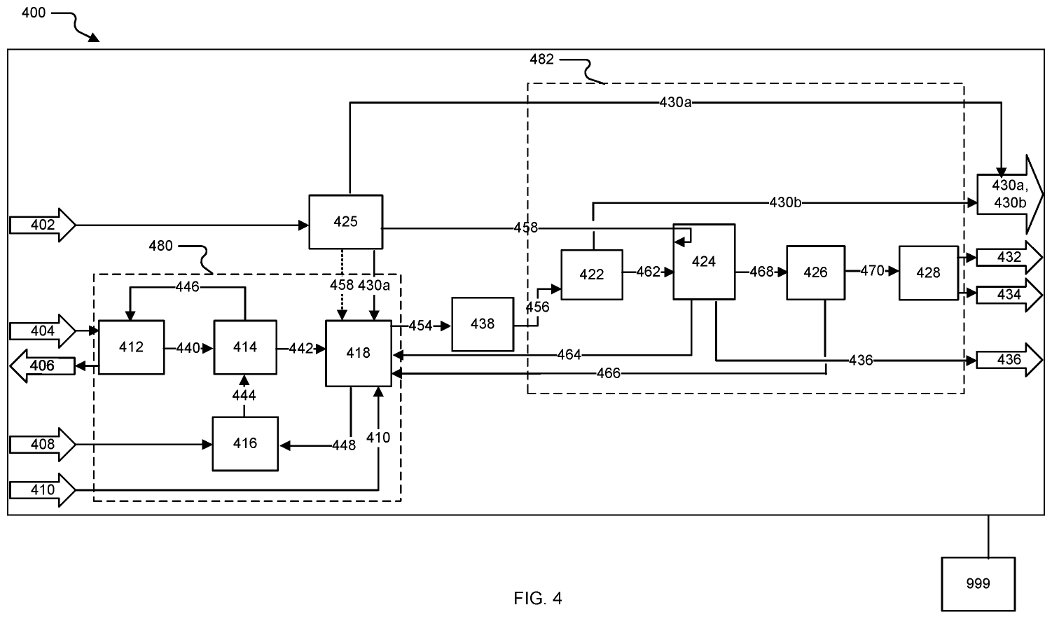

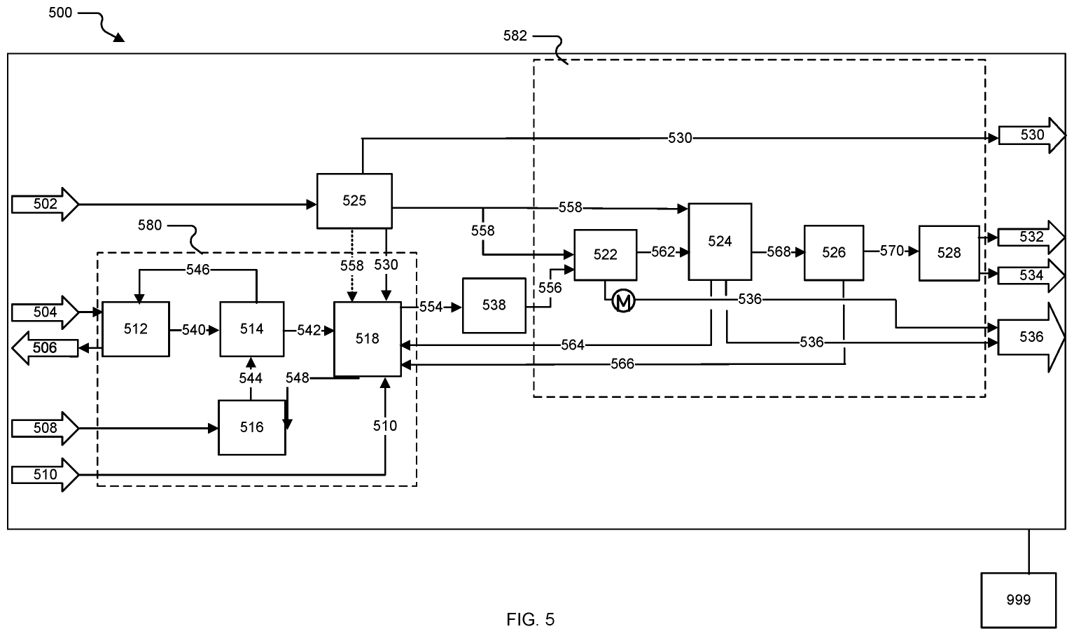

In other configurations, such as systems 400 and 500 of FIG. 4 and FIG. 5, respectively, the FT tail gas and/or the refined tail gas can be sent to the calciner instead and then combusted into CO₂. In some cases, an increased capacity of the hydrogen production subsystem may be needed to adjust to the additional CO₂ originating from the tail gases that are sent into the CO₂ capture subsystem (via the calciner) from the hydrocarbon production subsystem. In some cases, it is possible that recycling tail gases back into the hydrocarbon production subsystem via an ATR to produce syngas is economical since the capacity of the hydrogen production subsystem is less likely to be impacted.

The FT crude 268 includes mainly heavy end hydrocarbons which are liquid or solid. In the illustrated implementation of FIG. 2, the FT crude 268 is sent to a refining facility or refinery that includes a plurality of refining units 226 and/or distillation unit 228, where the FT crude 268 is subjected to refining and separation. Refining units 226 perform processes such as hydrocracking, hydrotreating, hydroisomerization, fluid catalytic cracking, thermal cracking, reforming, oligomerization, or a combination thereof to yield petroleum products. Non-limiting examples of process units (i.e., refining units 226 and distillation column 228) that make up a refining facility include process units including atmospheric distillation units, vacuum distillation units, hydrocrackers, thermal crackers, catalytic crackers, reformers, hydrotreaters, cokers, visbreakers, or alkylation units. These process units convert FT crude 268 into a plurality of refined products 270 and a refined tail gas 266. Similar to the FT tail gas 264, the refined tail gas 266 includes methane and other light ends, and can therefore be oxidized in the ATR 220 to produce syngas. The refined products 270 can include mainly liquid and solid petroleum products such as naphtha, gasoline, kerosene, jet fuel, diesel, base oils, waxes and other chemicals. The refined products 270 are sent to distillation unit 228 where they are separated through distillation into individual or blended products such as liquid fuels 232 and chemicals 234. Non-limiting examples of liquid fuels 232 can include naphtha, gasoline, kerosene, jet fuel, diesel, fuel oil, or a combination thereof.

In the implementation of the hydrocarbon production subsystem 282 of FIG. 2, the FT crude 268 is sent to the refining units 226 and thence to the distillation unit 228. In other possible implementations, the FT crude 268 can be first sent to the distillation unit 228 for separation before undergoing refining processes in the refining units 226. For example, the FT crude 268 can be sent to an atmospheric distillation unit 228 to separate the FT crude 268 into the refined tail gas 266, naphtha, distillates, and residue/waxes. The naphtha, distillates, and residue/waxes can then undergo refining processes such as hydroisomerization, fluid catalytic cracking, thermal cracking, reforming, oligomerization, or a combination thereof to produce synthetic fuel products including liquid fuels 232 and chemicals 234. The refined tail gas 266 can flow to the ATR 220, and the ATR 220 can oxidize methane CH₄ in the refined tail gas 266 using the oxygen 230 streams in the presence of steam 202 to produce the syngas 260 for FT synthesis.

Using the FT tail gas 264 from the FT reactor 224 and the refined tail gas 266 from the refining units 226 in the ATR 220 helps to reduce carbon emissions by recycling carbon atoms back into the system 200 that would have otherwise been emitted into the atmosphere. Further, in some aspects, flaring and venting of the FT tail gas 264 and the refined tail gas 266 can be reduced or eliminated, which reduces the overall carbon intensity of the system 200. The FT tail gas 264 and the refined tail gas 266 (referred to herein as the “tail gases”), which include primarily gaseous hydrocarbons ranging from C1 to C4, can be reformed using oxygen and steam in the autothermal reformer 220 to produce syngas 260. In some implementations, the ATR 220 can oxidize methane in the FT tail gas 264 and/or the refined tail gas 266 using oxygen 230 in the presence of both steam 202 and CO₂ to produce the syngas 260. For example, a portion of the recovered CO₂ feed stream 256 can be sent to the ATR 220 and the ATR 220 can oxidize the tail gases in the presence of the recovered CO₂ feed stream 256 and steam 202 to produce the syngas 260.

The hydrocarbon production subsystem 282 produces liquid fuels 232 and chemicals 234. Non-limiting examples of liquid fuels 232 can include jet fuel, aviation turbine fuel, diesel, or gasoline. In comparison to similar products produced from conventional fossil fuels, the liquid fuels 232 tend to have reduced content of pollutants such as sulfur, SOx, NOx, aromatic hydrocarbons and particulate matter because the liquid fuels 232 include mainly paraffins which burn cleanly (produce less particulate matter and hazardous pollutants). Since the liquid fuels 232 of the system 200 are comparatively purer, they are more desirable as a transportation fuel source. Furthermore, synthetic fuels derived from an atmospheric source of CO₂, such as those that can produced by system 200, tend to have fewer impurities to deal with in intermediate processing steps because atmospheric CO₂ generally does not have the same impurities as traditional carbon sources such as natural gas, biomass or coal.

In some aspects, system 200 can utilize heat integration between the CO₂ capture subsystem 280 and the hydrocarbon production subsystem 282. For example, steam generated from FT reactor 224, and/or refining units 226 can be used in the CO₂ capture subsystem 280. In some aspects, the hydrocarbon production subsystem 282 can produce high- and/or medium-pressure steam that can be utilized in the CO₂ capture subsystem 280. For example, the FT reactor 224 can produce high pressure steam. Steam may be used directly or indirectly (e.g., by using waste heat recovery methods) to heat process streams, evaporate water from the process streams, provide freeze protection, preheat and/or dry materials (e.g., CaCO₃ solids or CaO solids) in CO₂ capture subsystem 280. Utilizing waste heat can reduce the carbon intensity of the system 200, and of its products such as liquid fuels 232 and chemicals 234. Heat integration can improve process economics by reducing costs associated with energy requirements.

In some aspects, heat integration can also improve the functionality of certain process units and materials. For example, heating the CO₂ capture solution 246 can improve capture kinetics, thereby enabling more CO₂ to be captured from atmospheric air that flows through air contactor 212 at a given air velocity. For example, heating the discharge effluent of the pellet reactor 214 can improve performance of downstream separation units, such as centrifuge and filtration units. In some embodiments, this can be accomplished by using waste heat to warm the pellet reactor discharge stream, a slip stream from the pellet reactor 214 or filter/clarifier, and/or the feed stream to the filter/clarifier. For example, warmer water has properties which allow for faster settling, namely lower density and viscosity, as shown below by Stoke's law which relates liquid properties (density, viscosity), with solid settling velocity:

$$V = \frac{2}{9} \frac{( {ρ}_{p} - {ρ}_{f} )}{μ} {gR}^{2} ,$$

where V is a velocity at which a spherical particle will settle out of suspension, Pp is a mass density of the fluid spherical particle (kg·m⁻³), ρ_{f} is a mass density of the fluid (kg·m⁻³), g is acceleration of gravity (m·s⁻¹), R is a radius of the particle (m), and μ is a viscosity of the fluid (kg·m⁻¹·s⁻¹).

In some aspects, system 200 can utilize a cooling water system and process streams from the CO₂ capture subsystem 280 to cool other units within system 200. For example, units within the hydrogen production subsystem 225 and the hydrocarbon production subsystem 282 generate heat, and this heat can be transferred to cooling water that constitutes a closed cooling water loop. The cooling water loop can be common to multiple units across CO₂ capture subsystem 280, hydrogen production subsystem 225, and/or hydrocarbon production subsystem 282, thereby providing an integrated approach for servicing the cooling requirements of system 200. For example, the CO₂-laden capture solution 240 that flows from the air contactor 212 basin can be sent to a heat exchanger, where heat is transferred from the cooling water to the CO₂-laden capture solution 240. The CO₂-laden capture solution 240 can then flow to the pellet reactor 214. Thus, in some aspects, the CO₂ capture subsystem 280 operation can provide an opportunity to meet a cooling demand in the subsystems that constitute system 200. This differs from conventional heat management approaches where cooling systems for unit operations outside of a particular subsystem (e.g., the CO₂ capture subsystem) are typically independent. By integrating the cooling system across system 200, capital and operating costs as well as the carbon intensity of system 200 can be reduced.

In some aspects, in cold weather, supplemental heating can be provided to the capture solution (streams 646, 640) by utilizing waste heat from other units in the system 600, such as the calciner 618, the CO₂ reduction reactor, the autothermal reformer, the FT reactor, the refining units, or a combination thereof. Heat can be transferred from one process unit to another via a common cooling water system.

In some aspects, system 200 can generate electricity/energy using waste heat from the hydrocarbon production subsystem 282. For example, waste heat from the hydrocarbon production subsystem 282 can be used for power generation, by employing units such as a heat recovery steam generator that uses thermal energy to produce steam that is used in a steam turbine generator to produce electricity. By using waste heat from the process to produce electricity, imported electrical needs for the process can be reduced, thereby reducing capital and operating costs as well as the carbon intensity of system 200.

In some aspects, system 200 can utilize heat integration between the CO₂ capture subsystem 280 and the hydrogen production subsystem 225. For example, the hydrogen production subsystem 225 can include a water electrolyzer or a steam-methane reformer that produces heat, which can be used in the CO₂ capture subsystem 280. The CO₂ capture subsystem 280 has multiple applications for using low grade waste heat, such as for heating process streams to improve the performance of process units. For example, heating slurry streams can improve performance of filters and/or centrifuges. Using waste heat from the hydrogen production subsystem 225 can reduce the carbon intensity of system 200.

In some aspects, system 200 can consolidate water treatment for the hydrogen production subsystem 225 and the CO₂ capture subsystem 280. In some aspects, the hydrogen production subsystem 225 may include a water electrolyzer where the water source (e.g., municipal water, groundwater, wastewater, etc.) is purified in a water treatment facility or purification system before being fed to the water electrolyzer. The purification process may reduce fouling or degradation of the water electrolyzer. For example, the purification process may remove chloride ions and produce brine as a byproduct. The brine byproduct can then be recovered and used in the CO₂ capture subsystem 280 as process water make up. For example, the brine may be introduced to the CO₂ capture subsystem 280 via the slaker 216. Using the byproduct brine can reduce the net water demand of the process and reduce water disposal costs, while consolidating the water treatment for the CO₂ capture subsystem 280 and the hydrogen production subsystem 225.

In some aspects, system 200 can utilize water 236 that is produced by the FT reactor 224 in the CO₂ capture subsystem 280. At least some of the product water 236 from the FT reactor 224 can be recovered and treated to meet water quality requirements for the CO₂ capture subsystem 280. For example, after treatment, the water 236 can be reused in the CO₂ capture subsystem 280 for water makeup, where it may be used in the slaker 216 for the slaking reaction and/or to wash calcium carbonate CaCO₃ solids that are discharged from the pellet reactor 214.

In some aspects, system 200 can utilize the water 236 that is produced by the FT reactor 224 in the hydrogen production subsystem 225. For example, at least some of the product water 236 from the FT reactor 224 can be recovered and treated to meet water quality requirements for a water electrolyzer of the hydrogen production subsystem 225. After treatment, the water 236 can be used as feedstock instead of or in addition to water 202 for producing hydrogen 258 and oxygen 230 through water electrolysis. Using produced water 236 elsewhere in system 200 can reduce the overall water demand of the system 200 and reduce water disposal cost.

In some aspects, a high temperature exhaust stream from the calciner 218 exhaust stream can preheat the recovered CO₂ feed stream 256 that feeds the CO₂ reduction reactor 222. For example, a high temperature gas-to-gas heat exchanger can be used to exchange heat between the exhaust stream of the calciner 218 and the recovered CO₂ feed stream 256 feeding the CO₂ reduction reactor 222. In some cases, waste heat from the hydrogen production subsystem 225 (which may include a steam-methane reformer), the CO₂ reduction reactor 222, the ATR 220, or a combination thereof may be used to preheat the recovered CO₂ feed stream 256.

Some electrocatalytic CO₂ reduction reactors 222 operate at high temperatures (e.g., about 600° C. to 900° C.) because certain electrochemical properties (e.g., current density, cell potential, etc.) of these reactors are favorable at high temperatures. For these electrocatalytic CO₂ reduction reactors 222 that operate at high temperatures, preheating the recovered CO₂ feed stream 256 (for example, with heat transferred from the calciner 218) before it is fed into the electrocatalytic CO₂ reduction reactor 222 can reduce the energy load required from the electrocatalytic CO₂ reduction reactor 222. For example, the recovered CO₂ feed stream 256 can be between ambient temperature to 100° C., and then can be progressively heated via pre-heating steps that use heat exchangers.

In some aspects, system 200 can recover heat from CO₂ reduction reactor 222 product gases (e.g., CO 262 and oxygen 230) to preheat the recovered CO₂ feed stream 256. For example, at least one stage of heat exchange or at least one heat exchanger can be used to preheat of the recovered CO₂ feed stream 256. A first stage may include a metallic heat exchanger that operates at colder temperatures, and a second stage can include a ceramic heat exchanger due to metal dusting which can occur when handling hot syngas and/or CO 262. A ceramic heat exchanger can reduce or eliminate metals in contact with the process streams and thus eliminate metal dusting. In some aspects, recovering the heat from the hot syngas and/or CO 262 to preheat the recovered CO₂ feed stream 256 can reduce the energy demand and operating costs of system 200.

In some aspects, system 200 can recover heat from the CaO 248 to preheat the recovered CO₂ feed stream 256 feeding the CO₂ reduction reactor 122. For example, the recovered CO₂ feed stream 256 can contact CaO 248 to exchange heat in a cooling train of the calciner 218, thereby preheating the recovered CO₂ feed stream 256, while cooling the CaO 248. In some aspects, a high temperature baghouse installed downstream of the calciner 218 can reduce the amount of dust carried over from the calciner 218 into the CO₂ reduction reactor 222. To manage the large pressure differential between the recovered CO₂ feed stream 256 and the pressure of the CaO 248 multistage loop, seals can be employed to generate a pressure difference via a pressure drop across a fluidized bed. Recovering the heat from the cooled CaO 248 to preheat the recovered CO₂ feed stream 256 can also reduce energy demand and cost of system 200. Since reforming units like the CO₂ reduction reactor 222 are typically not co-located with another process unit, such as the calciner 218 that discharges solids at the temperatures at which the CO₂ reduction reaction occurs, such integration efficiencies are typically not available in conventional systems.

In some aspects, system 200 can utilize a process facility layout design to facilitate heat and material integration. For example, the land footprint of the hydrocarbon production subsystem 282 can be more compact compared to the land footprint of the CO₂ capture subsystem 280. The process units of the system 200 can be strategically located to reap heat and material integration benefits and reduce overall facility footprint. For example, co-locating (e.g., relatively close such as within approximately 250 m or less down to the shortest distance permitted by legislated requirements concerning electrical installations in hazardous locations) the CO₂ reduction reactor 222 and calciner 218, which both operate in similar high temperature ranges (800-950° C.), can enable close heat integration and minimization of heat loss and pressure drop. Co-location of the calciner 218 and the hydrocarbon production subsystem 282 is feasible due to the integration of DAC and fuel synthesis processes.

In some aspects, system 200 can combine compression requirements of one or more the subsystems by employing multi-duty compressors. For example, the FT recycle compression of the hydrocarbon production subsystem 282 can be combined with CO₂ compression and purification unit 238. The syngas 260 that flows from the ATR 220, the recovered CO₂ stream 254 that flows from the CO₂ capture subsystem 280, and the hydrogen 258 that flows from the hydrogen production subsystem 225 may each need to be compressed before flowing to their respective downstream units. Instead of employing independent compressors to compress each of these streams, a single compressor assembly 239 can be used. The single compressor assembly 239 can have multiple stages. For example, the electrocatalytic CO₂ reduction reactor 222 may only convert a portion of the recovered CO₂ feed stream 256 into CO 262. In some cases, the unconverted CO₂ may be recycled to the inlet of the electrocatalytic CO₂ reduction reactor 222 and may need to be compressed. The CO₂ recycle can be fed into compressor assembly 239 and combined with the recovered CO₂ feed stream 256 at the appropriate compressor stage. In implementations where streams that require compression are to remain separate from the recovered CO₂ feed stream 256, compressor assembly 239 may include an integrally geared compressor, and they can be compressed in a separate stage of an integrally geared compressor. In another implementation where streams are to remain separate from the recovered CO₂ feed stream 256, compressor assembly 239 may include a multi-stage compressor assembly where a first compressor is driven by the same motor shaft as a second compressor (e.g., the main CO₂ compressor), and the recovered CO₂ feed stream 256 is compressed in the first compressor while the other streams are compressed in the second compressor. In some cases, this can lower capital cost as one large compressor can be less costly than two individual smaller compressors.

Other configurations of systems for producing synthetic fuels from CO₂ in atmospheric air are possible. In some cases, a thermocatalytic CO₂ reduction reactor may be used instead of the electrocatalytic CO₂ reduction reactor 222, which may require some differences in the flow of process streams in comparison to system 200 of FIG. 2. In some implementations, the thermocatalytic CO₂ reduction reactor may utilize a modified Gas-to-Liquids platform that can convert CO₂ and hydrogen into syngas through a process known as Reverse Water Gas Shift (RWGS) before sending the syngas to an FT reactor to produce synthetic hydrocarbons. This enables the integration of DAC (e.g. the CO₂ capture subsystem 280) with mature FT technologies, which can lead to an easier scale up of the systems and methods for producing synthetic fuels from a DAC-derived source of CO₂.

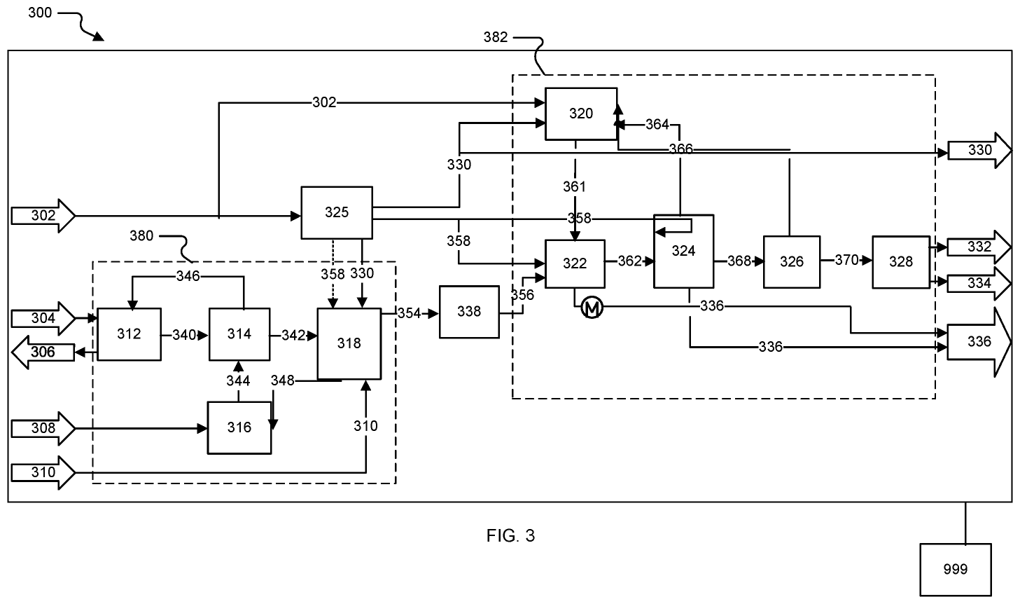

FIG. 3 is a schematic diagram of an example system 300 for producing synthetic fuels from CO₂ in atmospheric air that employs a thermocatalytic CO₂ reduction reactor 322 and an autothermal reformer 320. The system 300 includes a CO₂ capture subsystem 380, a hydrogen production subsystem 325, and a hydrocarbon production subsystem 382 that are fluidly coupled to one another. The description, features, reference numbers, and associated advantages provided above of the CO₂ capture subsystem 280, the hydrogen production subsystem 225, the hydrocarbon production subsystem 282, and other components of the system 200 of FIG. 2 apply mutatis mutandis to the CO₂ capture subsystem 380, the hydrogen production subsystem 325, the hydrocarbon production subsystem 382, and other like components of the system 300 of FIG. 3, respectively.

In the illustrated implementation of the system 300 of FIG. 3, the hydrogen production subsystem 325 flows a hydrogen stream 358 to the thermocatalytic CO₂ reduction reactor 322 and to the FT reactor 324. The thermocatalytic CO₂ reduction reactor 322 can react a variety of feedstocks, including but not limited to hydrogen, CO₂, methane, natural gas, oxygen, steam, light end hydrocarbons, and biomethane to produce syngas. In some cases, the thermocatalytic CO₂ reduction reactor 322 can employ one or more of the reactions described in Table 2 (see reactions listed for the thermocatalytic CO₂ reduction reactor). Referring to FIG. 3, the thermocatalytic CO₂ reduction reactor 322 produces a CO stream 362 and steam 336 by performing the RWGS reaction (CO₂+H₂⇄CO+H₂O) on the hydrogen 358 and on the recovered CO₂ feed stream 357 from the CO₂ capture subsystem 380. In some implementations, the thermocatalytic CO₂ reduction reactor 322 includes a catalyst bed in a packed bed reactor, a multi-tubular fixed bed reactor, or a combination thereof. In some implementations, the CO₂ thermocatalytic reduction reactor 322 may generate CO and H₂ via one or more of the reactions described above in Table 2, and may receive a hydrocarbon (e.g., methane) stream as a feedstock. The thermocatalytic CO₂ reduction reactor 322 may operate at high temperature, for example above 500° C., may operate at either atmospheric pressure or higher pressures of up to 200 bar, and may incorporate a variety of catalysts to participate in the key reactions. Embodiments of the thermocatalytic CO₂ reduction reactor 322 are described in greater detail below with reference to FIG. 10A and FIG. 10B. In contrast to an electrocatalytic CO₂ reduction reactor, the thermocatalytic CO₂ reduction reactor 322 produces steam 336 (i.e., water) instead of oxygen.

In some aspects, system 300 can utilize water 336 from the thermocatalytic CO₂ reduction reactor 322 as process water make up in the CO₂ capture subsystem 380. Water 336 can be recovered and treated prior to being used in the CO₂ capture subsystem 380. Water treatment may include removing dissolved species (gases or particulates) and balancing acidity. In some aspects, reusing produced water 336 elsewhere in system 300 can reduce overall water demand and water disposal costs.

The thermocatalytic CO₂ reduction reactor 322 flows CO 362 to an FT reactor 324. The FT reactor 324 receives hydrogen 358 from the hydrogen production subsystem 325 and reacts the CO 362 with hydrogen 358 in polymerization reactions to form an FT tail gas 364 and FT crude 368. The FT crude 368 flows to refining units 326, which processes the FT crude 368 into a refined tail gas 366 and a plurality of refined products 370. The description, features, reference numbers, and associated advantages of the FT reactor 224, FT tail gas 264, FT crude 268, refining units 226, refined tail gas 266, refined products 270, liquid fuels 232, and chemicals 234 provided above, in reference to FIG. 2, apply mutatis mutandis to the FT reactor 324, FT tail gas 364, FT crude 368, refining units 326, refined tail gas 366, refined products 370, liquid fuels 332, and chemicals 334 of FIG. 3, respectively.

In some cases, the thermocatalytic CO₂ reduction reactor 322 can be susceptible to coke formation if light hydrocarbons contaminate the feed. Coke formation can occur when hydrogen atoms are removed from hydrocarbons and cause a layer of elemental carbon to form. Coke formation is problematic because it can reduce the active area of the catalyst bed in the thermocatalytic CO₂ reduction reactor 322, thereby reducing the effectiveness of CO₂ conversion into syngas. An example reaction that can form coke is 3 C₂H₄→2 C+2 C₂H₆.

In some cases, the ATR 320 can reduce coke formation in the thermocatalytic CO₂ reduction reactor 322 and produce additional syngas (i.e., in addition to the hydrogen 358 formed by the hydrogen production subsystem 325 and the CO 362 formed by the thermocatalytic CO₂ reactor 322). The FT tail gas 364 and the refined tail gas 366 (referred to herein as “the tail gases 364, 366” for brevity) include mainly light end hydrocarbons (C1 to C4) and flow to the ATR 320. In the ATR 320, in the presence of steam 302 and oxygen 330, at least a portion of the tail gases 364, 366 can be reformed into syngas 361 (CH₄+1/2xO₂+yCO2+(1−x−y)H₂O← →(y+1) CO+(3−x−y)H₂) thereby producing additional syngas. The syngas 361 can then flow to the thermocatalytic CO₂ reduction reactor 322. Although it is optional for ATR 320 to react the tail gases 364, 366 to form the syngas 361 and to flow the syngas 361 to the thermocatalytic CO₂ reduction reactor 322, it can be an alternative to sending the tail gases directly to the thermocatalytic CO₂ reduction reactor 322, which can lead to coke formation, or to flaring/venting the tail gases 364, 366 into the atmosphere. Additionally, this enables the light end hydrocarbons in the tail gases 364, 366, which are generally less valuable petroleum products than target products like liquid fuels 332, to potentially be indirectly processed into a liquid fuel via syngas formation as an intermediate step. In some cases, the syngas 361 can flow from the ATR 320 directly to the FT reactor 324, thereby bypassing the thermocatalytic CO₂ reduction reactor 322.

The thermocatalytic CO₂ reduction reactor 322 can receive a thermal energy input from electrical heating or by combustion of fuel. For example, thermal energy can be generated from combusting hydrogen 358, natural gas 310, or a combination thereof.

In some aspects, the thermocatalytic CO₂ reduction reactor 322 can be operated at an intermediate pressure range (about 50-400 psi) to simplify reactor design and operation. For example, instead of compressing the feed to the thermocatalytic CO₂ reduction reactor 322 to a high pressure range (about 400-500 psi) and operating the hydrocarbon production subsystem 382 at a similarly high pressure, the feed streams to the FT reactor 324 and to the thermocatalytic CO₂ reduction reactor 322 can be compressed to an intermediate pressure. The pressure can be low enough to reduce the capital cost of the equipment by reducing challenges that relate to metallurgical limitations of thermocatalytic CO₂ reduction reactors, but can still be high enough to achieve sufficient reaction kinetics while also maintaining a reasonable land footprint. The thermocatalytic CO₂ reduction reactor 322 and/or the autothermal reformer 320 can be operated at the intermediate pressure range.

Operating the thermocatalytic CO₂ reduction reactor 322 at an intermediate pressure range can have other benefits. In some cases, the CO stream 362 that flows from the thermocatalytic CO₂ reduction reactor 322 can be compressed (to an intermediate pressure range) to knock out at least a portion of water vapor that may be residual, and then compressed to the feed pressure required for the FT reactor 324, which is higher than the intermediate pressure range. This can lower the capital cost of the thermocatalytic CO₂ reduction reactor 322 and/or autothermal reformer 320, as high temperature (approx. 900° C.) and pressure operation can pose challenges for the metallurgy of reformer tubes and/or tubes supporting a catalyst. The intermediate pressure range can be selected by assessing available reactor building material parameters of the thermocatalytic CO₂ reduction reactor 322 and/or autothermal reformer 320, such as design stress, yield stress, and ultimate tensile strength (UTS). For example, an intermediate pressure range can be selected by evaluating the pressures at which a lower grade of steel that forms the thermocatalytic CO₂ reduction reactor 322 can function safely and is deemed acceptable from a hazard and operability study, while keeping roughly the same ratio of design stress to yield stress and/or UTS. In some aspects, an intermediate pressure range or a lower operating pressure enable the use of a lower cost material (e.g., some steel alloys), as opposed to an expensive material (e.g., stainless steel), for the construction of the thermocatalytic CO₂ reduction reactor 322 and/or autothermal reformer 320.

Reformer tubes of the thermocatalytic CO₂ reduction reactor 322 and/or the ATR 320 are relatively large which typically increases their cost. As described above, reducing operating pressure may enable cost savings in the materials of the reformer tubes which can offset some of the increased costs associated with the large size. In some cases, the autothermal reformer 320 are operated within an intermediate pressure range because these pressures favor the products in the reforming reaction.

In addition to the heat integration approaches described above, with reference to FIG. 2, steam generated from the thermocatalytic CO₂ reduction reactor 322 can be used in CO₂ capture subsystem 380. For example, the thermocatalytic CO₂ reduction reactor 322 can produce high pressure steam that can be used in the ATR 220. Another example of heat integration between the CO₂ capture subsystem 380 and the hydrocarbon production subsystem 382 is the transfer of heat generated in the calciner 318 to the recovered CO₂ stream 354. In some aspects, the calciner 318 can be fluidly coupled to a ceramic baghouse that removes dust (e.g., CaCO₃ and CaO particles). The ceramic baghouse can be used at a discharge of the secondary cyclone of the calciner 318, which operates at about 900° C., to remove dust from the recovered CO₂ stream 354. With dust removed, recovered CO₂ stream 354 can be sent directly to the thermocatalytic CO₂ reduction reactor 322 without needing to be cooled and reheated, thus reducing or eliminating thermal energy requirements and improving process energy efficiency. This contrasts to conventional designs which can require cooling the CO₂ stream from 900° C. to 50° C. for storage and delivery, and then reheating the CO₂ stream to ˜900° C. for feeding to the thermocatalytic CO₂ reduction reactor 322. Processing the CO₂ stream to meet these fluctuating temperature requirements in conventional designs can result in energy inefficiencies.

Yet other configurations of systems for producing synthetic fuels from CO₂ in atmospheric air are possible. In some cases, the tail gases in the hydrocarbon production subsystem can be used in the CO₂ capture subsystem. For example, the tail gases can be combusted in the burner of a calciner to generate at least a portion of the thermal energy required for the calcination reaction. If the tail gases are sent to a calciner, then an autothermal reformer may not be required. Using the tail gases in the calciner can be an alternative to venting or flaring the tail gases into the atmosphere, as this approach recycles carbon into another process unit within the system rather than contributing to emissions. FIG. 4 and FIG. 5 illustrate example systems where tail gases are used in the calciner instead of being vented, thereby reducing the amount of carbon emitted from the system per unit of synthetic fuel produced (i.e., reducing the carbon intensity). Additionally, since flowing the tail gases from the hydrocarbon production subsystem to the calciner can allow for eliminating the autothermal reformer, there is a potential in capital cost savings.

FIG. 4 is a schematic diagram of an example system 400 that employs an electrocatalytic CO₂ reduction reactor 422 and recycles an FT tail gas 464 and a refined tail gas 466 to the CO₂ capture subsystem 480. The system 400 includes the CO₂ capture subsystem 480, a hydrogen production subsystem 425, and a hydrocarbon production subsystem 482 that are fluidly coupled to one another. The description, features, reference numbers, and associated advantages provided above of the CO₂ capture subsystem 280, 380, the hydrogen production subsystems 225, 325, the hydrocarbon production subsystems 282, 382, and other components of the systems 200, 300 of FIGS. 2 and 3 apply mutatis mutandis to the CO₂ capture subsystem 480, the hydrogen production subsystem 425, the hydrocarbon production subsystem 482, and other like components of the system 400 of FIG. 4, respectively.

Referring to FIG. 4, the FT tail gas 464 and/or the refined tail gas 466 (referred to herein as “tail gases 464, 466”) flow from the FT reactor 424 and the FT refining unit 426, respectively, for utilization in the calciner 418 of the CO₂ capture subsystem 480. The tail gases 464, 466 include mainly gaseous hydrocarbons ranging from C1 to C4 and can be combusted in the calciner 418 with an oxygen stream 430a. In some cases, the calciner 418 can combust both a natural gas 410 stream and the tail gases 464, 466 with oxygen 430a. In some cases, oxygen stream 430a is an electrolyzer oxygen stream.

The tail gases 464, 466 provide thermal energy for the calcination reaction in the calciner 418, which yields a recovered CO₂ stream 454 to feed to the electrocatalytic CO₂ reduction reactor 422. Combusting the tail gases 464, 466 can replace at least a portion of the natural gas 410 feed into the calciner 418, thereby reducing associated fossil-fuel based CO₂ emissions, while still meeting the specifications of the CO₂ feed required by the electrocatalytic CO₂ reduction reactor 422. This can reduce the carbon intensity of system 400 and of the liquid fuels 432 or chemicals 434 produced by the system 400.

Yet other configurations of systems for producing synthetic fuels from CO₂ in atmospheric air are possible. The approach for reusing the FT tail gas and the refined tail gas (referred to herein as “tail gases”) in the calciner that is described above can also be applicable to implementations that include a thermocatalytic CO₂ reduction reactor. If the tail gases are sent to a calciner instead of an autothermal reformer, then an autothermal reformer may not be required because the light end hydrocarbons in the tail gases will not be at risk of causing coke formation in the thermocatalytic CO₂ reduction reactor. This is because the tail gases will be undergoing combustion to produce thermal energy in the calciner, rather than undergoing a reforming reaction to produce syngas in the thermocatalytic CO₂ reduction reactor.

FIG. 5 is a schematic diagram of an example system 500 that employs a thermocatalytic CO₂ reduction reactor 522 and recycles an FT tail gas 564 and a refined tail gas 566 to a CO₂ capture subsystem 580. The system 500 includes the CO₂ capture subsystem 580, a hydrogen production subsystem 525, and a hydrocarbon production subsystem 582 that are fluidly coupled to one another. The FT tail gas 564 and the refined tail gas 566 flow from an FT reactor 524 and refining units 526, respectively, to a calciner 518 of the CO₂ capture subsystem 580 in a configuration that is similar to the flow of the FT tail gas 464 and the refined tail gas 466 from the FT reactor 424 and refining units 426 to the calciner 418 of the CO₂ capture subsystem 480 in FIG. 4. The hydrocarbon production subsystem 582 includes a thermocatalytic CO₂ reduction reactor 522 that is similar to the thermocatalytic CO₂ reduction reactor 322 of FIG. 3. Examples of thermocatalytic CO₂ reduction reactors are described in reference to FIGS. 10A and 10B. The description, features, reference numbers, and associated advantages provided above of the CO₂ capture subsystems 280, 380, 480, the hydrogen production subsystems 225, 325, 425, the hydrocarbon production subsystems 282, 382, 482 and other components of the systems 200, 300, 400 of FIGS. 2 to 4 apply mutatis mutandis to the CO₂ capture subsystem 580, the hydrogen production subsystem 525, the hydrocarbon production subsystem 582, and other like components of the system 500 of FIG. 5, respectively.

Operational flexibility and material integrations are important design considerations for DAC-based fuels production systems. It can be beneficial to implement buffer capacity so that certain units can continue operating while other units are not operating or operating below their design capacities. For example, a first process unit may be coupled to a second process unit via a buffer unit. The second process unit may need to be offline due to turnaround or maintenance, but the first process unit can continue operating as long as the buffer unit has capacity to store the materials produced by the first process unit. Buffer capacity enables a system to continue steady state operation and decouples units in case of process upsets, thereby reducing impacts on units that are upstream or downstream of an offline unit.

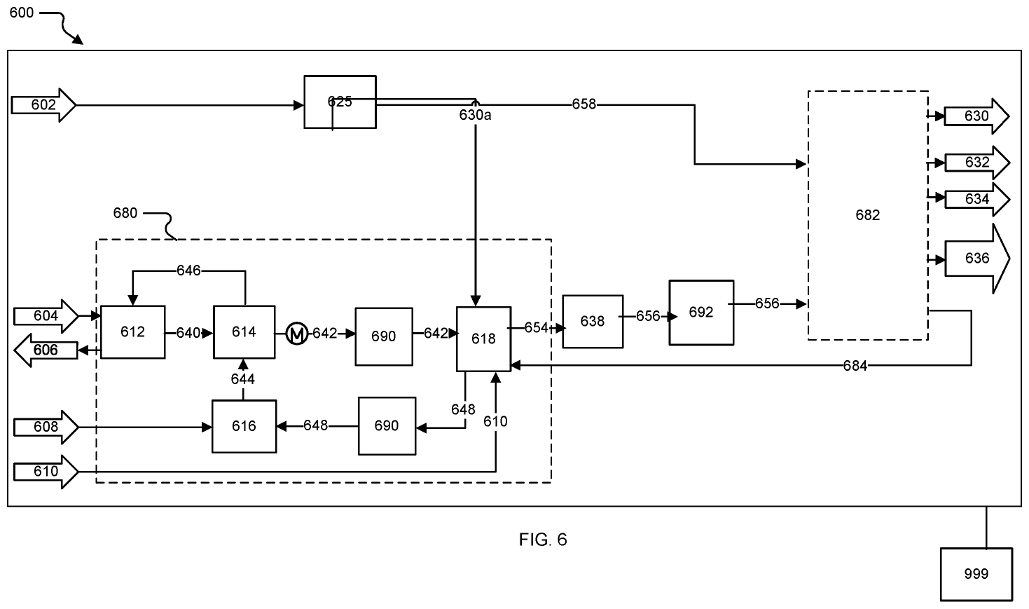

FIG. 6 is a schematic diagram of an example system 600 that employs buffer capacity and recycling of a liquid synthetic fuel within the system. System 600 includes a CO₂ capture subsystem 680, a hydrogen production subsystem 625, and a hydrocarbon production subsystem 682 that are fluidly coupled to one another. The description, features, reference numbers, and associated advantages of the hydrogen production subsystems 225, 325, 425, 525, the CO₂ purification and compression units 238, 338, 438, 538, and the hydrocarbon production subsystems 282, 382, 482, 582 of FIG. 2 through FIG. 5 provided above, apply mutatis mutandis to the hydrogen production subsystem 625, the CO₂ purification and compression unit 638, and the hydrocarbon production subsystem 682 of FIG. 6, respectively.

Referring to FIG. 6, the CO₂ capture subsystem 680 of system 600 includes at least one solids buffer storage tank 690 that is fluidly coupled to a calciner 618. The solids buffer storage tank 690 can provide buffer capacity that decouples the operation of units upstream and/or downstream of the calciner 618 (e.g., an air contactor 612, a pellet reactor 614, and a slaker 616). For example, the solids buffer storage tank 690 that is fluidly coupled to the pellet reactor 614 and the calciner 618 can collect calcium carbonate CaCO₃ to allow the pellet reactor 614, and units 20) upstream of the pellet reactor 614, to continue operating if the calciner 618 needs to operate at a reduced capacity or to go offline. For example, the solids buffer storage tank 690 that is fluidly coupled to the calciner 618 and the slaker 616 can collect calcium oxide CaO to allow the pellet reactor 614 and the calciner 618 to continue operating if the slaker 616 and/or the air contactor 612 needs to operate at a reduced capacity or to go offline. The solids buffer storage tank 690 can reduce the gap between feed demand and intermediate production of the individual unit operations within the system 600. As a result, each process unit can be operated in conditions that are best suited to its respective design with minimal to no impact by other units in the system 600.

In some aspects, system 600 can enable unique modes of operating the wet and dry loops of the systems. In some embodiments, the CO₂ capture subsystem 680 includes integrated wet and dry process loops. For example, the air contactor 612, the pellet reactor 614, and the slaker 616 are unit operations that utilize and/or regenerate the capture solution 646 and are sensitive to temperature fluctuations. During prolonged cold periods, such as in the winter season where low ambient air temperatures reduce the process solution temperature to below −5° C., these units can experience operational challenges, whereas the calciner 218 and the hydrocarbon production subsystem 682 are less sensitive to temperature. By incorporating solid buffer storage tanks 690, which can hold calcium carbonate CaCO₃ or calcium oxide CaO, the calciner 618 is able to continue operation when one or more of the air contactor 612, the pellet reactor 614, and the slaker 616 is at reduced capacity or offline.

Buffer capacity for fluids can be equally as important as and have similar benefits to buffer capacity for solids. The system 600 includes a liquid buffer storage tank 692 that is fluidly coupled to the CO₂ purification and compression unit 638 and the hydrocarbon production subsystem 682. The liquid buffer storage tank 692 can receive a recovered CO₂ stream 656 that has been liquefied in the CO₂ purification and compression unit 638. The liquefied CO₂ can sometimes be referred to as “CO₂ rundown”. For example, the CO₂ purification and compression unit 638 may include a cryogenic distillation unit that liquefies the CO₂, and the CO₂ rundown can flow to the liquid buffer storage tank 692. The liquid buffer storage tank 692 is pressurized. The liquid buffer storage tank 692 can provide temporary buffering between the CO₂ capture subsystem 680 and the hydrocarbon production subsystem 682.

Regarding material integrations, in some cases, there are certain non-gaseous hydrocarbons formed in the hydrocarbon production subsystem 682 that may be compatible with the CO₂ capture subsystem 680.

In some aspects, system 600 can include recycling a naphtha stream 684 from the hydrocarbon production subsystem 682 to the calciner 618 of the CO₂ capture subsystem 680. For example, the FT reactor and the refining units of the hydrocarbon production subsystem 682 can produce FT crude and refined products streams, respectively, and each of these streams can include naphtha (e.g., naphtha stream 684). A chemical composition of naphtha can vary depending on the process conditions under which it was formed, but typically includes C5-C10 hydrocarbon chains and is in liquid phase. In the FT crude, naphtha can include mainly linear alkenes and oxygenates. After being processed by the refining units into a refined product, naphtha can include branched chain hydrocarbons and can be substantially free of oxygenates. Naphtha can include linear alkenes, oxygenates, branched chain hydrocarbons, or a combination thereof. The naphtha stream 684 can flow from the hydrocarbon production subsystem 682 to the CO₂ capture subsystem 680 for utilization. For example, naphtha stream 684 can flow from the FT reactor and/or the refining units to the calciner 618 to be combusted.

Naphtha stream 684, through combustion with oxygen 630, can provide thermal energy for the calcination reaction, which yields a recovered CO₂ stream 654 to feed to the CO₂ reduction reactor. The calciner 618 includes a burner system which may require modifications to use the naphtha stream 684 as fuel. For example, the burner system of the calciner 618 may include a nebulizer coupled to the burner, and the nebulizer may mist the fuel (e.g., naphtha 684) into liquid fuel droplets to deliver it to the burner of the calciner 618. Combusting the naphtha stream 684 can replace at least a portion of the natural gas combusted in the calciner 618, thereby reducing associated fossil-fuel based CO₂ emissions and the carbon intensity of the system 600 and of the hydrocarbon products produced thereby.

For safety and product quality considerations, it can be important for the recovered CO₂ stream that is produced by the CO₂ production subsystem to be substantially free of impurities or residual gases (e.g., excess oxygen, water vapor, inert gases, etc.). For example, a target product composition of the recovered CO₂ stream may consist of at least 99 wt % CO₂. It is possible to remove these impurities or residual gases so that the recovered CO₂ stream meets the CO₂ quality requirements for storage, transport and usage in syngas production.

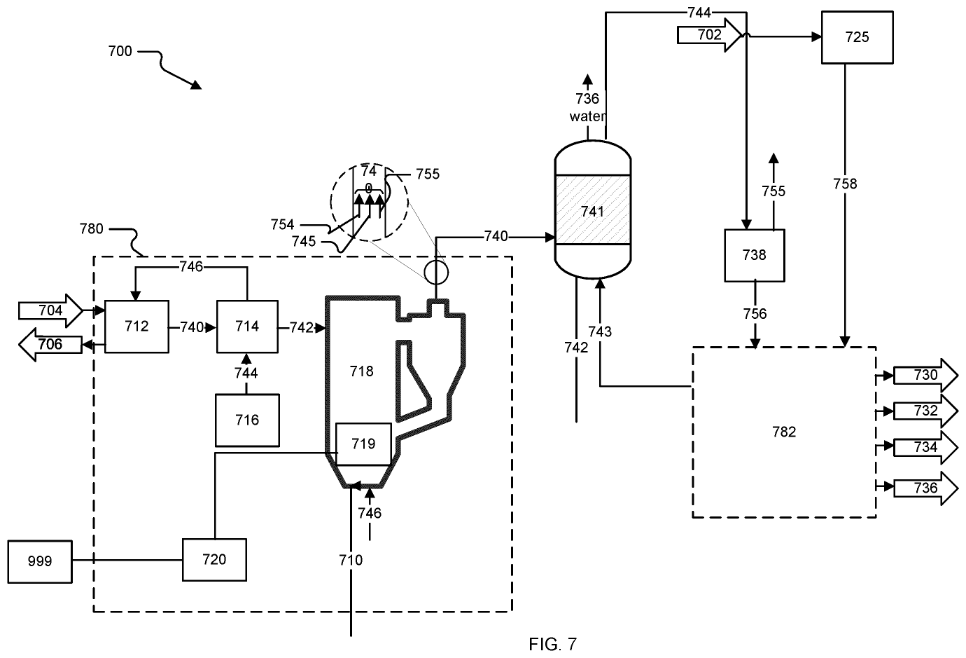

FIG. 7 is a schematic diagram of an example system 700 that includes a catalytic oxidation reactor 741 and a calciner combustion control system 720 to remove at least a portion of excess oxygen from a calciner exhaust stream 740 that includes a recovered CO₂ stream 754. In some implementations, one or both of the catalytic oxidation reactor 741 or the calciner combustion control system 720 is included. System 700 includes a CO₂ capture subsystem 780, a hydrogen production subsystem 725, and a hydrocarbon production subsystem 782 that are fluidly coupled to one another. The description, features, reference numbers, and associated advantages of the CO₂ capture subsystems 280, 380, 480, 580, 680, hydrogen production subsystems 225, 325, 425, 525, 625 the CO₂ purification and compression units 238, 338, 438, 538, 638, and the hydrocarbon production subsystems 282, 382, 482, 582, 682 of FIG. 2 through FIG. 6 provided above, apply mutatis mutandis to the CO₂ capture subsystem 780, the hydrogen production subsystem 725, the CO₂ purification and compression unit 738, and the hydrocarbon production subsystem 782 of FIG. 7, respectively.

In some aspects, the calciner exhaust stream 740 can include a recovered CO₂ stream 754, excess oxygen 745, and inerts 755. Excess oxygen 745 includes oxygen that remains unreacted from the combustion reaction in the calciner 718. Non-limiting examples of inerts 755 can include nitrogen, water vapor, and argon. Excess oxygen 745 and inerts 755 can mix with the recovered CO₂ 755 and be discharged from the calciner 718 as calciner exhaust stream 740.

System 700 includes a calciner combustion control system 720 that is communicatively coupled to control system 999 and a burner 719 in the calciner 718. The calciner combustion control system 720 may include temperature indicators, flow indicators, flow transmitters, flow ratio indicators, and other instrumentation that coupled to pipes that carry process streams flowing to and the calciner burner 719. For example, a pipe carrying natural gas, air, oxygen, a fluidization gas, or combination thereof may be in fluid communication with temperature indicators and flow transmitters that communicate with a control system 999. The calciner combustion control system 720 may also include burner or combustion indicators, pressure differential indicators for the flame within the burner 719. In some cases, switches, alarm devices, and pressure tap nozzles may also be included in the calciner combustion control system 720. The calciner combustion control system 720 reduces an amount of excess oxygen 745 in the calciner exhaust stream 740, and thereby in the recovered CO₂ stream 754 that flows to the hydrocarbon production subsystem 782. For example, the calciner combustion control system 720 sends a signal to the burner 719 and flow control systems coupled to the calciner 718 to operate the calciner 718 in a fuel-rich, oxygen-deficient manner. A fuel-rich, oxygen-deficient manner is where the feed gas molar ratios (e.g., the molar ratio of fuel to oxygen) are equal to or greater than the stoichiometric ratio that is required for the combustion reaction. Since there is a lower oxygen content than what is required for combustion (i.e., there is excess fuel), the amount of excess oxygen 745 in the calciner exhaust stream 740 is reduced (in comparison to a calciner that operates with feed gas molar ratios that are lower than the stoichiometric ratio required for combustion). By operating with this approach, the demands on the CO₂ purification and compression unit 738 are reduced or eliminated.

In some implementations, system 700 can include a catalytic oxidation reactor 741. The catalytic oxidation reactor 741 can include a catalyst bed within the catalytic oxidation reactor volume and an inlet that receives a combustible gas, oxygen, CO₂, water, or a combination thereof. In some cases, the catalyst bed supports a catalyst that includes platinum. The calciner exhaust stream 740 enters the catalytic oxidation reactor 741 and reacts with a combustible gas 742 (e.g., natural gas or tail gases 743 from the hydrocarbon production subsystem 782) over the catalyst bed. The excess oxygen 745 in the calciner exhaust stream 740 can react with the combustible gas 742 or tail gases 743 to form CO₂ and water 736. By implementing the catalytic oxidation reactor 741, the demands on the CO₂ purification and compression unit 738 can be reduced or eliminated. This can provide an efficient means of bridging a CO₂ product from CO₂ capture subsystem 780 with qualities of the feed gas specifications of the hydrocarbon production subsystem 782.

In some aspects, the catalytic oxidation reactor 741 of system 700 can utilize an FT tail gas and/or a refined tail gas produced in the hydrocarbon production subsystem 782 (referred to herein as “the tail gases 743”), or low-value combustible products (i.e., combustible hydrocarbons that are not target products), to consume excess oxygen 745 in the calciner exhaust stream 740. In some implementations, the CO₂ capture subsystem 780 can be operated in a manner where the fuel-to-oxygen ratio is lower than the stoichiometric ratio required for combustion (i.e., oxygen 745 is in excess). To remove the excess oxygen 745 in the calciner exhaust stream 740 (so that the recovered CO₂ product feed stream 756 feeding the CO₂ reduction reactor meets the required specifications), at least some of the tail gases 743 or other low-value combustible products can be combusted. In some implementations, an excess of the tail gases 743 and low-value combustible products can be fed into the catalytic oxidation reactor 741 to ensure that the excess oxygen 745 is consumed in the reaction. In some implementations, at least a portion of the feed gases, which include the calciner exhaust stream 740 and the tail gases 743 or low-value combustible gases, are preheated to a temperature that is higher than the auto-ignition temperature of the tail gases and/or other combustible gases. Preheating the feed gases can improve the performance of the CO₂ reduction reactor, thereby reducing operational costs.

In some aspects, system 700 can utilize approaches for managing inert buildup. The hydrocarbon production subsystem 782 may include a closed gas loop, where the tail gases 743 (C1-C4) from the FT reactor and/or the refining units are returned to a CO₂ reduction reactor or an autothermal reformer for conversion into CO and H₂. The tail gases 743 in the hydrocarbon production subsystem 782 may contain inert gases 746, such as nitrogen and argon that do not react in CO₂ reduction reactor, Fischer-Tropsch synthesis, and subsequent refining steps. Due to the closed gas loop design, inerts 755 can build up in the process streams and displace reactants, thereby reducing production rates. A conventional approach to addressing the buildup of inerts is to periodically purge the tail gases and the inert gases from the system. Periodic purging via venting to atmosphere (with or without flaring) is customary in conventional chemical processes, but purging can increase emissions and the carbon intensity of the system since the tail gases contain hydrocarbons.

In some aspects, to reduce or eliminate the need for carbon-emitting purge cycles, process streams containing the tail gases 743 and the inerts 755 can instead be sent to the catalytic oxidation reactor 741 and/or recycled to the CO₂ capture subsystem 780 via the calciner 718, where the tail gases 743 can be combusted to produce CO₂. In some cases, the combusted CO₂ can be captured. The inert gases 743 can carry over with the CO₂ from the catalytic oxidation reactor 741 and/or the calciner 718 and be removed in the CO₂ purification and compression system 738. The removed inert gases 746, which contain little to no carbon, can then be vented to the atmosphere without contributing significantly to the carbon intensity of the system 700.

Yet other configurations of systems for producing synthetic fuels from CO₂ in atmospheric air are possible. A hydrogen production subsystem may not be needed if a CO₂ reduction reactor that can produce both hydrogen and carbon monoxide is implemented in the system. This can also eliminate the need for an autothermal reformer, as syngas can be produced in a single unit rather than requiring the integration of multiple process units. This can reduce capital costs and simplify operation of the system.

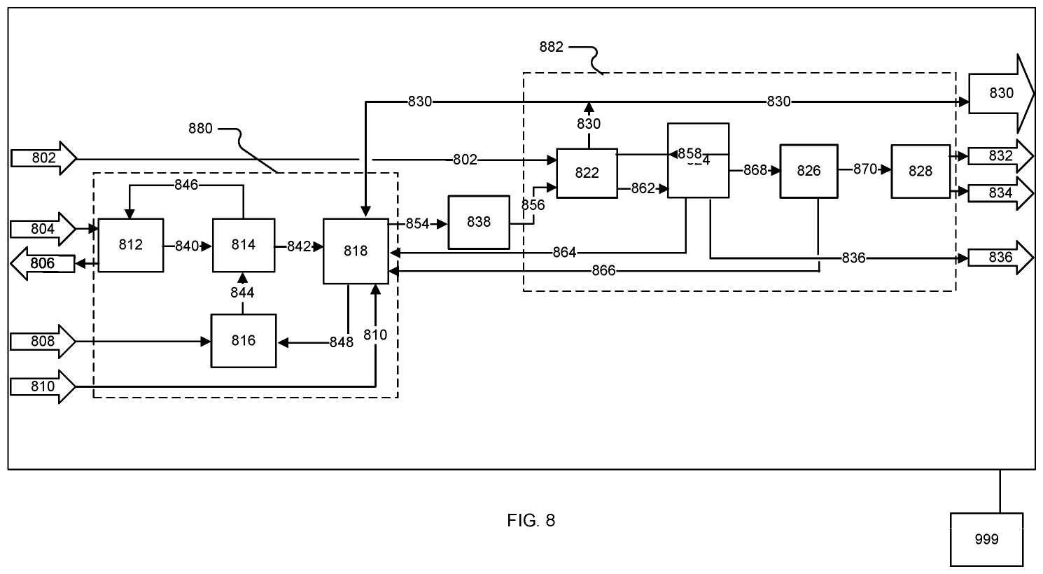

FIG. 8 is a schematic diagram of an example system 800 that employs a CO₂ reduction reactor 822 that produces a hydrogen 858 stream and a CO 862 stream. The system 800 includes a CO₂ capture subsystem 880 and a hydrocarbon production subsystem 882 that are fluidly coupled to one another. The description, features, reference numbers, and associated advantages provided above of the CO₂ capture subsystems 280, 380, 480, 580, 680, 780, the hydrogen production subsystems 225, 325, 425, 525, 625, 725, and other components of the systems 200, 300, 400, 500, 600, 700 of FIGS. 2 to 7 apply mutatis mutandis to the CO₂ capture subsystem 880, the hydrocarbon production subsystem 882, and other like components of the system 800 of FIG. 8, respectively.

The hydrocarbon production subsystem 882 includes the CO₂ reduction reactor 822 that reacts a water stream 802 and a recovered CO₂ feed stream 856 to form hydrogen 858, CO 862, and an oxygen stream 830. In some implementations, the CO₂ reduction reactor 822 includes a solid oxide electrolysis cell (SOEC) and is thus a possible configuration of the electrocatalytic CO₂ reduction reactor disclosed herein. The SOEC is an electrochemical unit that can employ a solid material as the electrolyte and can operate at high temperatures of around 800° C. The SOEC produces hydrogen 858 and CO 862 by electrolyzing water and reducing CO₂ over a catalyst. In some cases, the catalyst includes zirconias. Embodiments of an SOEC are described in greater detail below, with reference to FIG. 9A. In some implementations, the CO₂ reduction reactor 822 produces a sufficient amount of syngas (i.e., hydrogen 858, CO 862) to feed to an FT reactor 824.

The FT reactor 824 and a plurality of refining units 826 can form an FT tail gas 864 and a refined tail gas 866, respectively. In some aspects, the FT tail gas 864 and the refined tail gas 866 (referred to herein as “tail gases”) flow from the hydrocarbon production subsystem 882 to a calciner 818 of the CO₂ capture subsystem 880. In some implementations, an autothermal reactor is not required and the tail gases can therefore be used in the calciner 818 instead.

Electrochemical approaches to reducing CO₂ into CO can be used in a system for producing synthetic fuels from CO₂ in atmospheric air. For example, if a renewable or low carbon emissions energy source can be used to implement electrochemical CO₂ reduction in a DAC to fuels system, the overall carbon intensity of the system can be reduced.

FIG. 9A and FIG. 9B are schematic diagrams of example electrocatalytic CO₂ reduction reactors 900, 901 that include an anode 902, a cathode 904, and an electrolyte 906. Generally, the anode 902 and/or the cathode 904 will support a catalyst material that facilitates the reduction reactions that occur.

Referring to FIG. 9A, electrocatalytic CO₂ reduction reactor 900 includes an anode 902 fluidly and electrically coupled to a cathode 904 by an electrolyte 906. In some implementations the electrocatalytic CO₂ reduction reactor 900 can operate at a temperature of around 800° C.

In some cases, electrocatalytic CO₂ reduction reactor 900 can be a solid oxide electrolysis cell (SOEC), where the electrolyte 906 includes a solid CO₂ from a recovered CO₂ feed stream 256, 456, 656, 756, 856 of a CO₂ capture subsystem 280, 480, 680, 780, 880 that can enter the electrocatalytic CO₂ reduction reactor 900 on the cathode side. An electric potential is applied to the anode 902 and the cathode 904 (referred to herein as “electrodes”), which causes the reduction of CO₂ into CO molecules and oxygen ions. In some implementations, the electric potential that is applied can include voltages ranging from between 0.95 V and 1.35 V. The oxygen ions are then oxidized into oxygen molecules on the anode 902 side. In some cases, hydrogen can also be produced in the solid oxide electrolysis cell by splitting water into molecular hydrogen and oxygen ions at the cathode 904. In some implementations, the electrolyte 906 can include zirconia. In some implementations, the anode 902 and/or the cathode 904 can include nickel or platinum.

In some cases, electrocatalytic CO₂ reduction reactor 900 can be a molten carbonate electrolysis cell, where the electrolyte 906 includes a carbonate salt. CO₂ from a recovered CO₂ feed stream of a CO₂ capture subsystem can be used to replenish carbonate ions in the electrolyte 906. An electric potential is applied to the anode 902 and the cathode 904, which causes carbonate ions from the electrolyte 906 to be reduced to CO molecules and oxygen ions. The oxygen ions are then oxidized into oxygen molecules on the anode 902 side. In some implementations, the anode 902 and/or the cathode 904 can include titanium or graphite.

Referring to FIG. 9B, electrocatalytic CO₂ reduction reactor 901 includes the anode 902 fluidly and electrically coupled to the cathode 904 by an electrolyte 906. The electrodes can be flanked by fluid channels 910 that allow reactants and products to flow to and from the electrocatalytic CO₂ reduction reactor 901. In some implementations, the electrocatalytic CO₂ reduction reactor 901 can operate at a temperature that is lower than 100° C.

In some cases, the electrocatalytic CO₂ reduction reactor 901 can be a low temperature electrolysis cell or a polymer electrolyte membrane cell, where the electrolyte 906 includes an aqueous solution or a membrane and the fluid channels 910a, 910b can flow a liquid electrolyte. For example, the electrolyte 906 can be an alkaline liquid electrolyte, a cationic exchange polymer membrane, or an anionic exchange polymer membrane. An electric potential is applied to the anode 902 and the cathode 904, which causes CO₂ from the recovered CO₂ feed stream to be reduced to CO molecules and oxygen ions. The oxygen ions may move through the electrolyte 906 to the anode 902 side where they are oxidized into oxygen molecules. The electrolyte 906 may enable the movement or transfer of charge carriers like hydroxide OH-ions from the cathode 904 to the anode 902 to enable the production of CO and oxygen. In some cases, the anode 902 or the cathode 904 can be a gas diffusion electrode. For example, the cathode 904 can be a gas diffusion electrode that allows CO to diffuse out of the reactor. In such cases, the fluid channel 910b may be a gas channel that allows for the inflow of CO₂ and outflow of CO. In some cases, the CO₂ reduction reactor 901 may include a catalyst that includes iron, platinum, a non-precious metal, or a combination thereof.

In some implementations, any of the electrocatalytic CO₂ reduction reactors 900, 901 are combinable with any of the elements described herein. For example, the systems 200, 400, 800 of FIGS. 2, 4 and 8 can include the electrocatalytic CO₂ reduction reactor 900, 901 of FIGS. 9A and 9B.

Thermocatalytic approaches for generating CO from CO₂ are possible for producing synthetic fuels from CO₂ in atmospheric air. In some cases, thermocatalytic approaches may be more mature than electrochemical approaches because they are based on modified technologies adapted from conventional FT synthesis processes. For example, a thermocatalytic approach may implement a RWGS reaction (CO₂+H₂⇄CO+H₂O) as described in Table 2 to produce CO from CO₂.

FIG. 10A and FIG. 10B are schematic diagrams of example thermocatalytic CO₂ reduction reactors 1000, 1001. Thermocatalytic CO₂ reduction reactors 1000, 1001 each include a CO₂ reduction reactor vessel where a CO₂ reduction catalyst 1006 is supported. The CO₂ reduction reactor vessel has multiple openings that form a combination of inlets and outlets. The thermocatalytic CO₂ reduction reactors 1000, 1001 include a reactant inlet 1008 that can flow a feed gas mixture 1002 including CO₂ recovered from atmospheric air and hydrogen, and a product outlet 1010 that can flow a products mixture 1004 including CO and water. In some cases, the constituents of the feed gas mixture 1002 are mixed and then preheated before flowing into the reactant inlet 1008. In some implementations, there may be more than one reactant inlet 1008 that receives a respective gaseous species. The feed gas mixture 1002 can enter the CO₂ reduction reactor vessel and react over the CO₂ reduction catalyst 1006 to produce the product gas mixture 1004. In some implementations, catalyst 1006 may include cobalt, iron, copper, zinc, aluminum, or a combination thereof. The RWGS reaction may require thermal energy which is produced from a thermal energy source 1012, such as a natural gas burner, an electric heater, a heat exchanger, or a combination thereof constituting part of a cooling/heating system. In some cases, the feed gas mixture 1002 may be pre-heated by the thermal energy source 1012 prior to entering the CO₂ reduction reactor vessel. In some cases, a heat transfer media such as water vapor or nitrogen may be used to transfer heat (either directly or indirectly) from the thermal energy source 1012 to the feed gas mixture 1002. In some cases, the heat transfer media can be a heating jacket that encloses the outer shell of the CO₂ reduction reactor vessel. The heat transfer media may enter the thermocatalytic CO₂ reduction reactor 1000, 1001 through a thermal energy input 1014 and exit through a thermal energy output 1016.

Referring to FIG. 10A, thermocatalytic CO₂ reduction reactor 1000 is an example packed bed reactor. The CO₂ reduction catalyst 1006 may be packed into a fixed catalyst bed within the CO₂ reduction reactor vessel. The catalyst bed is heated to sufficient reaction temperatures (e.g., ranging from 180° C. to 850° C., depending on the catalyst) by the thermal energy source 1012. As the feed gas mixture 1002 that includes CO₂ recovered from atmospheric air flows through the cavity of the CO₂ reduction reactor vessel and over the catalyst 1006, the products mixture 1004 that includes CO is produced and discharged from the reactor.

Referring to FIG. 10B, thermocatalytic CO₂ reduction reactor 1001 is an example multi-tubular fixed bed reactor. The CO₂ reduction catalyst 1006 may fill a bundle of catalyst tubes 1018 that form the catalyst bed within the CO₂ reduction reactor vessel. The catalyst bed is heated to sufficient reaction temperatures (e.g., ranging from 180° C. to 850° C., depending on the catalyst) by the thermal energy source 1012. In some cases, a heat transfer media that conveys heat from the thermal energy source 1012 may flow through the cavity of the CO₂ reduction reactor vessel (i.e., on the “shell” side of the thermocatalytic reactor 1001). The feed gas mixture 1002 that includes CO₂ recovered from atmospheric air flows into the bundle of catalyst tubes 1018 and forms the product mixture 1004 as it flows through the length of the catalyst tubes 1018. The products mixture 1004 that includes CO is discharged from the reactor.

In some implementations, any of the thermocatalytic CO₂ reduction reactors 1000, 1001 are combinable with any of the elements described herein. For example, the systems 300, 500 of FIGS. 3 and 5 can include the thermocatalytic CO₂ reduction reactor 1000, 1001 of FIGS. 10A and 10B.

Hydrogen is required to produce a synthetic fuel. There are different feedstocks that can be used to produce hydrogen. Non-limiting examples of such feedstocks include water, methane, and light hydrocarbons. To lower the carbon intensity for a system for producing synthetic fuels from atmospheric CO₂, it is possible to use hydrogen production methods that are powered by renewable energy and/or coupled to a carbon capture system.

FIG. 11A and FIG. 11B are schematic diagrams of example hydrogen production subsystems 1100, 1101. Hydrogen can be produced using electrochemical approaches, reforming approaches coupled with carbon capture, or a combination thereof. These approaches are commonly referred to respectively as “green hydrogen” and “blue hydrogen” in the hydrogen production industry.

Referring to FIG. 11A, the hydrogen production subsystem 1100 can be a water electrolyzer that includes a membrane 1106 positioned between an anode 1102 and a cathode 1104. The membrane 1106 is permeable to and conductive of hydrogen ions (protons) and can include a polymer electrolyte membrane. Water is fed into the water electrolyzer and an electric potential is applied to the anode 1102 and the cathode 1104. The difference in electric potential decomposes water into oxygen and protons. The membrane 1106 conducts the protons to the cathode 1104 side where hydrogen molecules are evolved from the protons. The hydrogen can then be sent to a hydrocarbon production subsystem to produce a synthetic fuel, and the oxygen can be utilized in other process units in the system.

Referring to FIG. 11B, the hydrogen production subsystem 1101 can be steam-methane reformer that includes a burner 1112 that is thermally coupled to a plurality of reformer tubes 1114 within a reformer furnace 1120. The burner receives and combusts a gas mixture 1110 that includes natural gas and oxygen to generate thermal energy. A feed gas 1108 that includes methane and steam flows into the reformer tubes 1114 at a steam-to-methane ratio ranging between 3 to 5, and the thermal energy is transferred to initiate a steam-methane reforming reaction (CH₄+H₂O← →CO+3 H₂) as described in Table 2. The reformer tubes 1114 can support a catalyst that includes nickel. For example, the catalyst may include Ni/MgAl₂O₄. As the reaction occurs along the length of the tubes 1114, a hydrogen stream 1116 is produced and discharged from the steam-methane reformer. The steam-methane reformer can operate at temperatures ranging between 600° C. to 950° C. In some cases, other reactions and unit operations may be implemented to increase the amount of hydrogen that is produced. For example, a water gas shift reaction (CO+H₂O← →CO₂₊₃ H₂) and pressure swing absorber may be implemented. A pressure swing absorber removes at least a portion of CO₂ and impurities, thereby yielding a relatively pure hydrogen stream. The CO₂ from the combustion reaction initiated by the burner 1112 can flow through a stack 1122. In some implementations, the stack 1122 is fluidly coupled to a carbon capture and sequestration system 1124 that extracts the CO₂, compresses and cools it into a supercritical fluid, and injects it into a permanent storage location (e.g., saline formation, depleted reservoir, etc.). This can lower the carbon intensity of the hydrogen production subsystem 1101.

In some implementations, the hydrogen production subsystem 1101 can include a gasification unit that processes biomass, coal, or coke, where the gasification unit is fluidly coupled to the carbon capture and sequestration system 1124. In some implementations, the hydrogen production subsystem 1100, 1101 can include a hydrogen pipeline that flows liquid or gaseous hydrogen. In some cases, the hydrogen pipeline may flow hydrogen that is from a source located outside the battery limits of a CO₂ capture subsystem and a hydrocarbon production subsystem.

In some implementations, hydrogen production subsystem 1100 of FIG. 11A is combinable with any of the elements described herein. For example, the system 200 of FIG. 2 can include the hydrogen production subsystem 1100 of FIG. 11A. In some implementations where hydrogen production subsystem 1101 of FIG. 11B is included, an oxygen source may be need to feed unit operations that require oxygen as a reactant. For example, the oxygen source may include an air separation unit, an electrolysis cell that provides oxygen, or a combination thereof. In some cases, the oxygen source may be located outside the battery limits of a CO₂ capture subsystem and a hydrocarbon production subsystem.

In some implementations, the CO₂ capture subsystem of a system for synthesizing a fuel from a CO₂ source may function by contacting atmospheric air with a liquid sorbent that extracts CO₂ from atmospheric air. For example, the liquid sorbent can include an aqueous alkaline solution, an aqueous amine solution, an aqueous amino acid solution, an aqueous carbonate and/or bicarbonate solution, with or without containing promoters such as carbonic anhydrase. FIG. 12 shows an example CO₂ capture subsystem 1200 that employs a liquid sorbent (also referred to herein as “CO₂ capture solution”). CO₂ capture subsystem 1200 can be operated in a system (and associated process) for synthesizing a fuel from a dilute CO₂ source such as atmospheric air, similarly to the system 100.

The CO₂ capture subsystem 1200 can include an air contactor 1204 that employs a CO₂ capture solution 1212 for extracting CO₂ directly from atmospheric air 1202, according to a non-limiting example of a use for the air contactor 1204. The air contactor 1204 absorbs some of the CO₂ from the atmospheric air 1202 using the CO₂ capture solution 1212 to form a CO₂ rich solution 1208. In some implementations, the CO₂ capture solution 1212 can include solutions of potassium hydroxide (KOH), sodium hydroxide (NaOH), or a combination thereof. A hydroxide-containing CO₂ capture solution may react with CO₂ from atmospheric air to form a CO₂-rich solution 1208 that includes solutions of potassium carbonate (K₂CO₃), sodium carbonate (Na₂CO₃), potassium bicarbonate (KHCO₃), sodium bicarbonate (NaHCO₃), or a combination thereof.

The CO₂ capture solution 1212 may need to be regenerated from the CO₂-rich capture solution 1208, which can be carried out in a regeneration system 1230 as part of CO₂ capture subsystem 1200. The regeneration system 1230 functions to process the CO₂-rich capture solution 1208 (e.g., spent capture solution) to recover and/or concentrate the CO₂ content laden in the CO₂-rich capture solution 1208.

In an example regeneration system 1230, the CO₂ rich solution 1208 flows from the air contactor 1204 to a pellet reactor 1210 of the CO₂ capture subsystem 1200. The pellet reactor 1210 may include equipment such as a fluidized bed reactive crystallizer. Calcium hydroxide (Ca(OH)₂) 1224 is injected into the pellet reactor 1210. A reaction between the CO₂-rich solution and the calcium hydroxide 1224 occurs in the pellet reactor 1210. Ca²⁺ from the calcium hydroxide 1224 reacts with CO₃²⁻ from the CO₂-rich solution 1208 in the pellet reactor 1210, which forms calcium carbonate (CaCO₃) solids and the hydroxide solution as the CO₂ capture solution, thereby regenerating the CO₂ capture solution 1212. For example, K₂CO₃ can react with Ca(OH)₂ to form CaCO₃ and KOH, thereby regenerating the CO₂ capture solution 1212 including KOH.

The reaction of the CO₂-rich solution with Ca(OH)₂ causes precipitation of CaCO₃ onto calcium carbonate particles in the pellet reactor 1210 to grow calcium carbonate solids 1214. Further processing of the calcium carbonate solids 1214 may occur, including but not limited to filtering, washing, dewatering or drying. The calcium carbonate solids 1214 are transported from the pellet reactor 1210 to a calciner 1216 of the CO₂ capture subsystem 1200.

The calciner 1216 calcines the calcium carbonate solids 1214 from the pellet reactor 1210 to recover a stream of gaseous CO₂ 1218 (also referred to herein as “a recovered carbon dioxide feed stream”) and to form calcium oxide (CaO) 1220. The calcination reaction is performed at a high temperature (typically in the range of about 550-1150° C.). Thermal energy required for calcination can be generated by oxy-combustion of a fuel source in the calciner 1216. In some implementations, thermal energy for calcination can be generated electrically and/or the calciner 1216 can be thermally coupled to an electric heater. The recovered CO₂ stream 1218 is processed in downstream units such as a compression and purification system. The recovered CO₂ 1218 can be used for synthesizing fuels in a hydrocarbon production subsystem, such as the hydrocarbon production subsystems of the present disclosure. The stream of calcium oxide (CaO) 1220 is slaked with water, via a hydration reaction, in a slaker 1222 of the CO₂ capture subsystem 1200 to produce the calcium hydroxide 1224 that is provided to the pellet reactor 1210. The slaker 1222 can include a detention slaker, high temperature hydrator, steam slaker, paste slaker, lime hydrators, or a combination thereof. The CO₂ capture subsystem 1200 may include multiple air contactors 1204 that constitute a train/assembly of air contactors 1204. The CO₂ capture subsystem 1200 can also include a solids removal and clean-up unit that removes water and/or impurities from a material stream, and can include a baghouse, electrostatic precipitator, chiller, heat exchanger, condenser, or a combination thereof.

In some implementations, the CO₂ capture solution 1212 may be regenerated using a different regeneration system. The regeneration system 1230 may be part of the air contactor 1204 or separate therefrom. In an example regeneration system 1230, the CO₂-rich solution 1208 may flow to an electrochemical system that includes a cell stack, which may include a set of one or more membranes, and a set of electrodes. The electrochemical system can regenerate the CO₂ capture solution 1212 from CO₂-rich solution 1208 by applying an electric potential to an electrolyte including the CO₂-rich solution 1208. The difference in electric potential causes ion exchange, thereby forming the recovered CO₂ 1218 and regenerating the CO₂ capture solution 1212. In an example regeneration system 1230, the CO₂ rich solution 1208 may flow to a thermal stripping column that employs steam to desorb CO₂ from the CO₂ rich solution 1208, thereby forming the recovered CO₂ stream 1218 and regenerating the CO₂ capture solution (e.g., CO₂-lean liquid).

The regeneration system 1230 can include liquid distribution pipes, solids conveying equipment, filtration systems, intermediate components like storage vessels, and/or an assembly of components which function cooperatively to regenerate the CO₂ capture solution 1212. The regeneration system 1230 also includes pumps which flow liquids to and from the regeneration system 1230.

In some implementations, the CO₂ capture subsystem 1200 of FIG. 12 is combinable with, or substitutable for, any of the CO₂ capture subsystems disclosed herein.

Solid sorbents can be used to extract CO₂ from atmospheric air. The capture mechanisms for solid sorbents may differ from the capture mechanisms of some liquid sorbents. The approaches for desorbing/recovering the CO₂ and for regenerating solid sorbents can utilize different chemistries and unit operations. Some non-limiting examples of solid sorbents are described below.

FIG. 13 is a schematic diagram of an example CO₂ capture subsystem 1300 including solid sorbents. CO₂-laden air 1302 (e.g., atmospheric air) can flow into an air contactor 1304 that supports a solid sorbent. The CO₂-laden air 1302 can transfer at least a portion of CO₂ to the solid sorbent via absorption or adsorption to form a CO₂-lean air stream 1306, which is discharged out of the air contactor 1304. The air contactor 1304 can be fluidly coupled to a regeneration system 1318 that desorbs the CO₂ as a recovered CO₂ stream 1320 and regenerates the solid sorbent. In one possible implementation, the regeneration system 1318 includes a calciner to produce the recovered CO₂ stream 1320 and regenerate the solid sorbent. The recovered CO₂ stream 1320 can then be sent to a CO₂ reduction reactor of hydrocarbon production subsystem to be processed into synthetic fuel, as described above.

A plurality of solid sorbents are illustrated in FIG. 13. They are generally used independently of one another, but in some cases, the CO₂ capture subsystem 1300 may use a combination of multiple sorbents. In some implementations, the air contactor 1304 of the CO₂ capture subsystem 1300 may contact atmospheric air 1302 with a solid sorbent material including, but not limited to, being of non-carbonaceous origin (zeolites 1316, silica, metal-organic frameworks 1314 and porous polymers, alkali metal, and metal oxide carbonates) and of carbonaceous origin (activated carbons and/or carbon fibers, graphene, ordered porous carbons, fibers), a solid structure with chemical sorbent materials including functional amine-based materials 1308 with or without cellulose, a solid polymer based material including polyethyleneimine silica, an ion exchange resin 1312, or combinations of any of the above. In some implementations, the regeneration system 1318 of the CO₂ capture subsystem can include a thermal swing desorption unit, pressure swing desorption unit, humidity swing desorption unit, vacuum pump, thermal or steam stripper, calciner, electrochemical cell, or a combination thereof. For example, the CO₂-laden air 1302 can contact a solid sorbent including calcium oxide CaO or calcium hydroxide Ca(OH)₂ in the air contactor 1304 to form calcium carbonate CaCO₃ as an intermediate material. The CaCO₃ can then flow to a calciner in the regeneration system 1318 and undergo a calcination reaction, thereby forming the recovered CO₂ stream 1320 that is discharged from the CO₂ capture subsystem 1300. The recovered CO₂ stream 1320 can then be processed into a synthetic fuel via a hydrocarbon production subsystem.

In some implementations, the CO₂ capture subsystem 1300 of FIG. 13 is combinable with, or substitutable for, any of the CO₂ capture subsystems disclosed herein.

Systems 200, 300, 400, 500, 600, 700, 800 can also include a control system (or flow control system) 999 that is integrated with and/or communicably coupled with one or more components of the respective system 200, 300, 400, 500, 600, 700, 800. For example, the process streams in the system 200 can be flowed using one or more flow control systems (e.g., control system 999) implemented throughout the system 200. A flow control system can include one or more flow pumps, fans, blowers, or solids conveyors to move the process streams, one or more flow pipes through which the process streams are flowed and one or more valves to regulate the flow of streams through the pipes. Each of the configurations described herein can include at least one variable frequency drive (VFD) coupled to a respective pump that is capable of controlling at least one liquid flow rate. In some implementations, liquid flow rates are controlled by at least one flow control valve.

In some embodiments, a flow control system can be operated manually. For example, an operator can set a flow rate for each pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some embodiments, a flow control system can be operated automatically. For example, the flow control system can be connected to a computer or control system (e.g., control system 999) to operate the flow control system. The control system can include a computer-readable medium storing instructions (such as flow control instructions and other instructions) executable by one or more processors to perform operations (such as flow control operations). An operator can set the flow rates and the valve open or close positions for all flow control systems distributed across the facility using the control system. In such embodiments, the operator can manually change the flow conditions by providing inputs through the control system. Also, in such embodiments, the control system can automatically (that is, without manual intervention) control one or more of the flow control systems, for example, using feedback systems connected to the control system. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to the control system. In response to the flow condition exceeding a threshold (such as a threshold pressure value, a threshold temperature value, or other threshold value), the control system can automatically perform operations. For example, if the pressure or temperature in the pipe exceeds the threshold pressure value or the threshold temperature value, respectively, the control system can provide a signal to the pump to decrease a flow rate, a signal to open a valve to relieve the pressure, a signal to shut down process stream flow, or other signals.

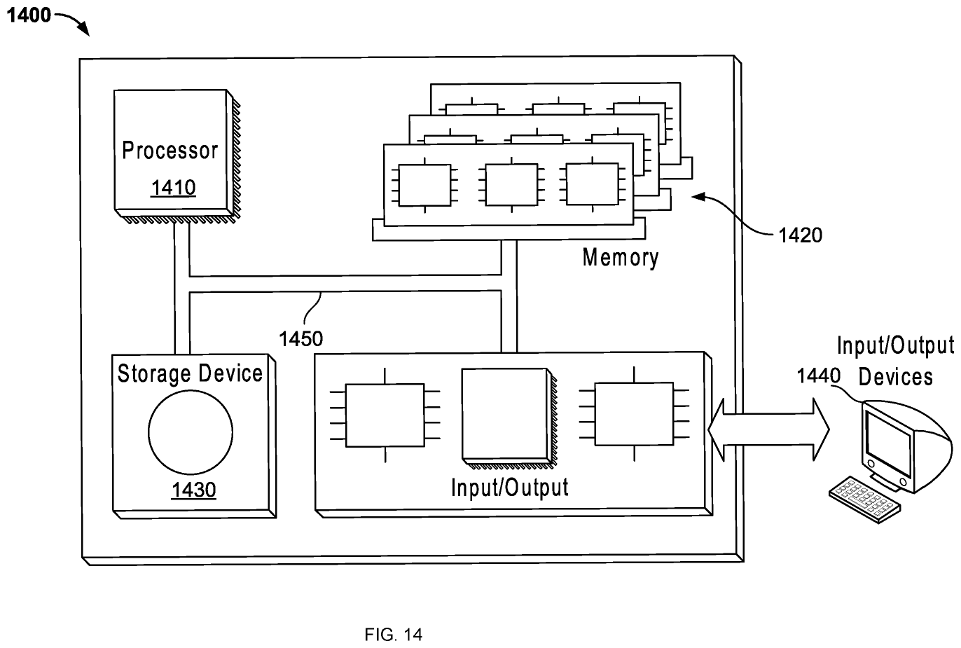

FIG. 14 is a schematic diagram of a control system (or controller) 1400 for a system for producing a synthetic fuel, such as system 200 shown in FIG. 2. The system 1400 can be used for the operations described in association with any of the computer-implemented methods described previously, for example as or as part of the control system 999 or other controllers described herein.

The system 1400 is intended to include various forms of digital computers, such as laptops, desktops, workstations, personal digital assistants, servers, blade servers, mainframes, and other appropriate computers. The system 1400 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1400 includes a processor 1410, a memory 1420, a storage device 1430, and an input/output device 1440. Each of the components 1410, 1420, 1430, and 1440 are interconnected using a system bus 1450. The processor 1410 is capable of processing instructions for execution within the system 1400. The processor may be designed using any of a number of architectures. For example, the processor 1410 may be a CISC (Complex Instruction Set Computers) processor, a RISC (Reduced Instruction Set Computer) processor, or a MISC (Minimal Instruction Set Computer) processor.

In one implementation, the processor 1410 is a single-threaded processor. In some implementations, the processor 1410 is a multi-threaded processor. The processor 1410 is capable of processing instructions stored in the memory 1420 or on the storage device 1430 to display graphical information for a user interface on the input/output device 1440.

The memory 1420 stores information within the system 1400. In one implementation, the memory 1420 is a computer-readable medium. In one implementation, the memory 1420 is a volatile memory unit. In some implementations, the memory 1420 is a non-volatile memory unit.

The storage device 1430 is capable of providing mass storage for the system 1400. In one implementation, the storage device 1430 is a computer-readable medium. In various different implementations, the storage device 1430 may be a floppy disk device, a hard disk device, an optical disk device, or a tape device.

The input/output device 1440 provides input/output operations for the system 1400. In one implementation, the input/output device 1440 includes a keyboard and/or pointing device. In some implementations, the input/output device 1440 includes a display unit for displaying graphical user interfaces.

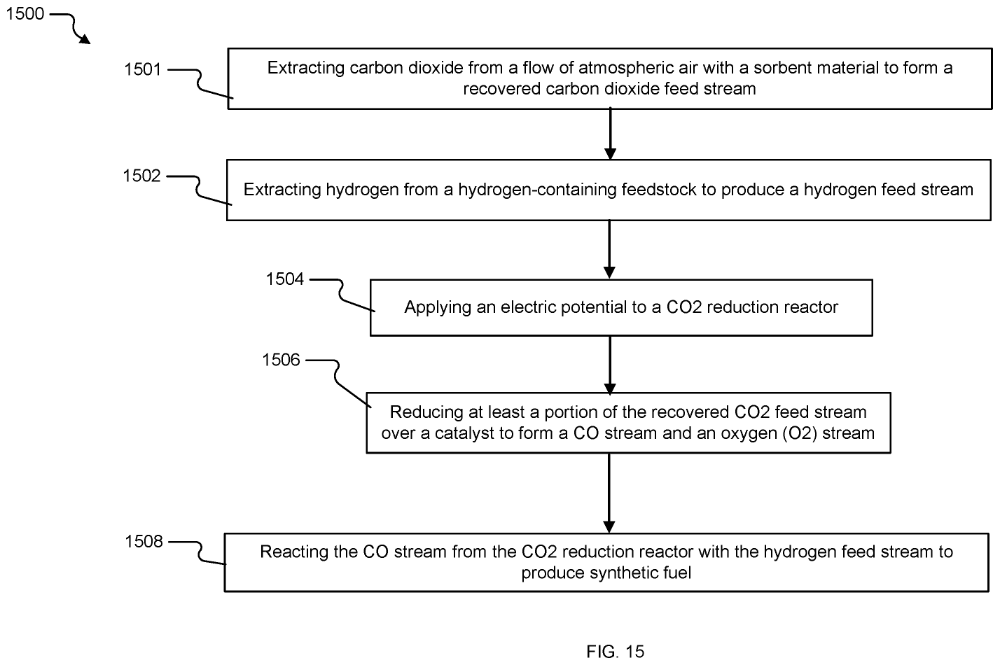

Referring to FIG. 15, a method 1500 for producing a synthetic fuel is disclosed. At 1501, the method 1500 includes extracting carbon dioxide from a flow of atmospheric air (e.g., streams 204, 404 of FIGS. 2 and 4, respectively) with a sorbent material to form a recovered carbon dioxide feed stream (e.g., recovered carbon dioxide feed streams 256, 456 of FIGS. 2 and 4, respectively). At 1502, the method 1500 includes extracting hydrogen from a hydrogen-containing feedstock to produce a hydrogen feed stream (e.g., hydrogen feed streams 258, 458 of FIGS. 2 and 4, respectively). The method 1500 includes processing the recovered carbon dioxide feed stream in a CO₂ reduction reactor to produce a CO stream by using an electrocatalytic CO₂ reduction reactor. At 1504, the method 1500 includes applying an electric potential to a CO₂ reduction reactor (e.g., CO₂ reduction reactor 222, 422 of FIGS. 2 and 4, respectively). At 1506, the method 1500 includes reducing at least a portion of the recovered CO₂ feed stream over a catalyst to form a CO stream (e.g., CO streams 262, 462 of FIGS. 2 and 4, respectively) and an oxygen stream (e.g., oxygen streams 230, 430 of FIGS. 2 and 4, respectively). At 1508, the method 1500 includes reacting the CO stream from the CO₂ reduction reactor with the hydrogen feed stream to produce synthetic fuel.

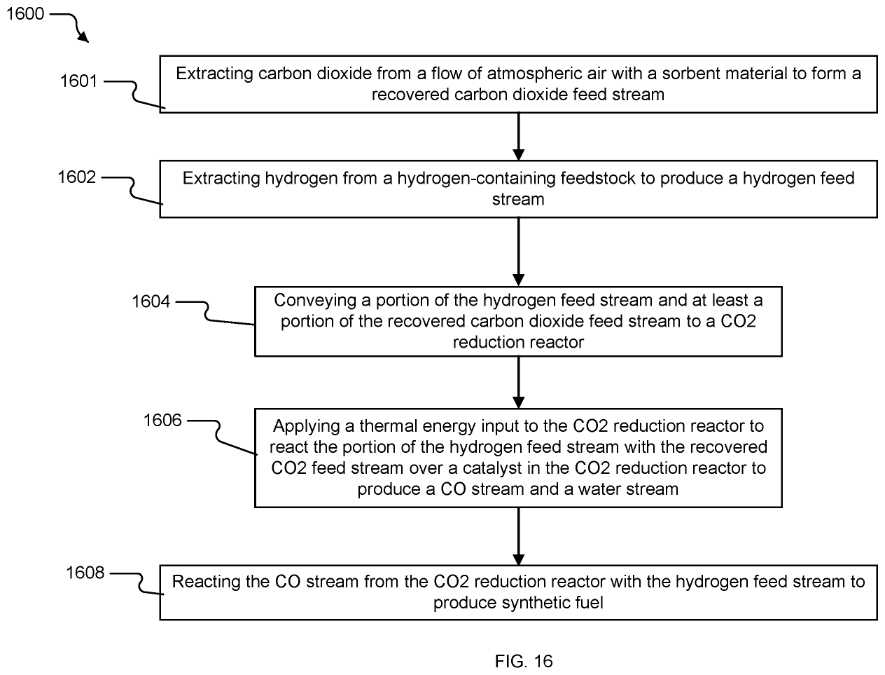

Referring to FIG. 16, a method 1600 for producing a synthetic fuel is disclosed. At 1601, the method 1600 includes extracting carbon dioxide from a flow of atmospheric air (e.g., streams 304, 504 of FIGS. 3 and 5, respectively) with a sorbent material to form a recovered carbon dioxide feed stream (e.g., recovered carbon dioxide feed streams 356, 556 of FIGS. 3 and 5, respectively). At 1602, the method 1600 includes extracting hydrogen from a hydrogen-containing feedstock to produce a hydrogen feed stream (e.g., hydrogen feed streams 358, 558 of FIGS. 3 and 5, respectively). The method 1600 includes processing the recovered carbon dioxide feed stream in a CO₂ reduction reactor to produce a CO stream by using a thermocatalytic CO₂ reduction reactor. At 1604, the method 1600 includes conveying a portion of the hydrogen feed stream to a CO₂ reduction reactor (e.g., CO₂ reduction reactor 322, 522 of FIGS. 3 and 5, respectively). At 1606, the method 1600 includes applying a thermal energy input to the CO₂ reduction reactor to react the portion of the hydrogen feed stream with the recovered CO₂ feed stream over a catalyst in the CO₂ reduction reactor to produce a CO stream (e.g., CO stream 362, 562 of FIGS. 3 and 5, respectively) and a water stream (e.g., water stream 336, 536 of FIGS. 3 and 5). At 1608, the method 1600 includes reacting the CO stream from the CO₂ reduction reactor with the hydrogen feed stream to produce synthetic fuel.

Certain features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The term “couple” and variants of it such as “coupled,” “couples,” and “coupling” as used in this description is intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. In particular, a fluid coupling means that a direct or indirect pathway is provided for a fluid to flow between two fluidly coupled devices. Also, a thermal coupling means that a direct or indirect pathway is provided for heat energy to flow between to thermally coupled devices.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A method for producing a synthetic fuel, comprising:
extracting carbon dioxide (CO₂) from a flow of atmospheric air with a sorbent material to form a recovered carbon dioxide feed stream;
extracting hydrogen (H₂) from a hydrogen-containing feedstock to produce a hydrogen feed stream;
processing the recovered carbon dioxide feed stream in a CO₂ reduction reactor to produce a carbon monoxide (CO) stream by:
applying an electric potential to the CO₂ reduction reactor; and
reducing at least a portion of the recovered carbon dioxide feed stream over a catalyst to form the carbon monoxide stream and an oxygen (O₂) stream; and
reacting the carbon monoxide stream from the CO₂ reduction reactor with the hydrogen feed stream to produce the synthetic fuel.

2. The method of claim 1, wherein extracting the carbon dioxide from the flow of atmospheric air with the sorbent material to form the recovered carbon dioxide feed stream comprises:
reacting the carbon dioxide in the flow of atmospheric air with a CO₂ capture solution to form a CO₂-lean gas and a carbonate-rich capture solution;
reacting the carbonate-rich capture solution with a calcium hydroxide stream to form at least a portion of the CO₂ capture solution and to precipitate calcium carbonate solids; and
calcining at least a portion of the calcium carbonate solids to extract the recovered carbon dioxide feed stream.

3. The method of claim 2, wherein reacting the carbon dioxide in the flow of atmospheric air with the CO₂ capture solution comprises reacting the carbon dioxide in the flow of atmospheric air with at least one of potassium hydroxide or sodium hydroxide.

4. The method of claim 2, wherein calcining at least the portion of the calcium carbonate solids comprises combusting a fuel comprising at least one of natural gas or hydrogen.

5. The method of claim 4, wherein combusting the fuel comprising at least one of natural gas or hydrogen comprises combusting at least a portion of the hydrogen feed stream.

6. The method of claim 2, wherein calcining at least the portion of the calcium carbonate solids comprises electrically heating the calcium carbonate solids.

7. The method of claim 2, wherein reacting the carbon monoxide stream from the CO₂ reduction reactor with the hydrogen feed stream comprises:
reacting the hydrogen feed stream and the carbon monoxide stream in a Fischer-Tropsch (FT) process to form an FT crude stream;
refining the FT crude stream to form a refined crude stream comprising naphtha; and
the method further comprises combusting at least a portion of the naphtha to generate thermal energy, wherein calcining at least the portion of the calcium carbonate solids comprises calcining at least the portion of the calcium carbonate solids with the thermal energy.

8. The method of claim 1, wherein extracting hydrogen from the hydrogen-containing feedstock comprises electrolyzing water to form the hydrogen feed stream and an electrolyzer oxygen stream.

9. The method of claim 1, wherein extracting hydrogen from the hydrogen-containing feedstock comprises steam-methane reforming to form the hydrogen feed stream.

10. The method of claim 1, wherein reacting the carbon monoxide stream from the CO₂ reduction reactor with the hydrogen feed stream comprises reacting the hydrogen feed stream and the carbon monoxide stream in a Fischer Tropsch (FT) process to form an FT crude stream.

11. The method of claim 1, wherein:
processing the recovered carbon dioxide feed stream in the CO₂ reduction reactor comprises conveying only the carbon monoxide stream from the CO₂ reduction reactor to a Fischer-Tropsch (FT) process; and
reacting the carbon monoxide stream from the CO₂ reduction reactor with the hydrogen feed stream comprises reacting the carbon monoxide stream conveyed from the CO₂ reduction reactor with the hydrogen feed stream in the FT process to form an FT crude stream.

12. The method of claim 1, further comprising:
oxidizing at least a portion of a combustible gas using the oxygen stream from the CO₂ reduction reactor in an autothermal reformer to form a syngas stream.

13. The method of claim 12, wherein:
reacting the carbon monoxide stream from the CO₂ reduction reactor with the hydrogen feed comprises reacting the carbon monoxide stream from the CO₂ reduction reactor with the hydrogen feed stream in a Fischer Tropsch (FT) process to form an FT crude stream and an FT tail gas stream; and
the method further comprises refining the FT crude stream to produce a refined tail gas stream and a refined crude stream.

14. The method of claim 13, wherein oxidizing at least the portion of the combustible gas comprises oxidizing at least one of the FT tail gas stream, the refined tail gas stream, or a natural gas stream.

15. The method of claim 12, wherein reacting the carbon monoxide stream from the CO₂ reduction reactor with the hydrogen feed stream comprises reacting, in a Fischer Tropsch (FT) process, the syngas stream from the autothermal reformer, the carbon monoxide stream and the hydrogen feed stream to form an FT crude stream and an FT tail gas stream.

16. The method of claim 15, wherein reacting the carbon monoxide stream from the CO₂ reduction reactor with the hydrogen feed stream comprises:
refining the FT crude stream to form a refined crude stream and a refined tail gas stream; and
distilling the refined crude stream to form the synthetic fuel, the synthetic fuel comprising a liquid fuels stream and a chemicals stream.

17. The method of claim 1, wherein extracting hydrogen from hydrogen compounds in the hydrogen feedstock to produce the hydrogen feed stream further comprises:
dissociating a water stream over the catalyst in the CO₂ reduction reactor to form the hydrogen feed stream and another portion of the oxygen stream.

18. The method of claim 2, wherein:
reacting the carbon monoxide stream from the CO₂ reduction reactor with the hydrogen feed stream comprises:
reacting the hydrogen feed stream and the carbon monoxide stream via a Fischer-Tropsch (FT) process to form an FT tail gas stream and an FT crude stream; and
refining the FT crude stream to form a refined tail gas stream and a refined crude stream; and
calcining at least the portion of the calcium carbonate solids to extract the recovered carbon dioxide feed stream comprises combusting at least one of the FT tail gas stream or the refined tail gas stream.

19. The method of claim 1, wherein:
the recovered carbon dioxide feed stream comprises excess oxygen; and
the method further comprises removing at least a portion of the excess oxygen in the recovered carbon dioxide feed stream.

20. The method of claim 19, wherein removing at least the portion of the excess oxygen in the recovered carbon dioxide feed stream comprises:
combusting at least the portion of the excess oxygen with a fuel, wherein a molar ratio of the fuel to the excess oxygen is equal to or greater than a combustion stoichiometric ratio.

21. The method of claim 19, wherein removing at least the portion of the excess oxygen in the recovered carbon dioxide feed stream comprises:
catalytically oxidizing a combustible gas with at least the portion of the excess oxygen to form a catalytic oxidation product stream comprising carbon dioxide and water; and
combining the carbon dioxide of the catalytic oxidation product stream with the recovered carbon dioxide feed stream,
wherein the combustible gas comprises at least one of natural gas, a Fischer-Tropsch tail gas, or a refined tail gas.

22. The method of claim 21, wherein catalytically oxidizing the combustible gas with at least the portion of the excess oxygen comprises:
combusting at least the portion of the excess oxygen with the combustible gas at an auto-ignition temperature of the combustible gas.

23. The method of claim 1, further comprising:
liquefying the recovered carbon dioxide feed stream; and
maintaining at least a portion of the liquefied carbon dioxide feed stream in a liquid storage tank before processing the recovered carbon dioxide feed stream in the CO₂ reduction reactor.

24. The method of claim 23, wherein liquefying the recovered carbon dioxide feed stream comprises separating contaminants from the recovered carbon dioxide feed stream in at least one of a cryogenic distillation unit, a membrane separation unit, or water knockout unit.

25. The method of claim 1, wherein:
reacting the carbon monoxide stream from the CO₂ reduction reactor with the hydrogen feed stream generates heat; and
the method further comprises transferring at least a portion of the heat to the step of extracting the carbon dioxide from the flow of atmospheric air with the sorbent material to form the recovered carbon dioxide feed stream.

26.-28. (canceled)

29. The method of claim 1, further comprising:
compressing a gaseous process stream by operating a single compressor assembly, the gaseous process stream comprising at least one of the recovered carbon dioxide feed stream, steam, carbon monoxide, hydrogen, a Fischer-Tropsch tail gas, or a refined tail gas.

30. A method for producing a synthetic fuel comprising:
extracting carbon dioxide from a flow of atmospheric air with a sorbent material to form a recovered carbon dioxide feed stream;
processing the recovered carbon dioxide feed stream in a carbon dioxide (CO₂) reduction reactor to produce a carbon monoxide (CO) stream by:
applying an electric potential to the CO₂ reduction reactor; and
reducing at least a portion of the recovered carbon dioxide feed stream over a catalyst to form the carbon monoxide stream and an oxygen (O₂) stream; and
reacting the carbon monoxide stream from the CO₂ reduction reactor with a hydrogen (H₂) stream to produce the synthetic fuel.

31. A system for producing a synthetic fuel, comprising:
a carbon dioxide (CO₂) capture subsystem configured to extract carbon dioxide from a flow of atmospheric air with a sorbent material to produce a recovered carbon dioxide feed stream;
a hydrogen production subsystem configured to extract hydrogen from a hydrogen-containing feedstock to produce a hydrogen feed stream; and
a hydrocarbon production subsystem comprising a CO₂ reduction reactor configured to process the recovered carbon dioxide feed stream to produce a carbon monoxide (CO) stream, the hydrocarbon production subsystem configured to react the hydrogen feed stream with the carbon monoxide stream from the CO₂ reduction reactor to produce the synthetic fuel.

32. The system of claim 31, wherein:
the sorbent material comprises a CO₂ capture solution; and
the CO₂ capture subsystem comprises a pellet reactor fluidly coupled to a calciner, the pellet reactor configured to react the CO₂ capture solution to precipitate calcium carbonate solids and the calciner configured to calcine at least a portion of the calcium carbonate solids.

33.-36. (canceled)

37. The system of claim 31, wherein the hydrogen production subsystem comprises a water electrolyzer configured to form the hydrogen feed stream and an oxygen stream.

38. (canceled)

39. The system of claim 31, wherein the hydrocarbon production subsystem comprises a Fischer-Tropsch (FT) reactor fluidly coupled to the CO₂ reduction reactor to receive the carbon monoxide stream from the CO₂ reduction reactor, the FT reactor configured to form an FT crude stream.

40. The system of claim 31, wherein the CO₂ reduction reactor comprises a solid oxide electrolysis cell comprising a zirconias-containing electrolyte and an electrode comprising nickel or platinum.

41. The system of claim 31, wherein the CO₂ reduction reactor comprises a molten carbonate electrolysis cell comprising a carbonate-containing electrolyte and an electrode comprising titanium or graphite.

42. The system of claim 31, wherein the CO₂ reduction reactor comprises a polymer electrolyte membrane fuel cell comprising at least one of an alkaline aqueous solution or a solid membrane.

43. The system of claim 31, wherein the CO₂ reduction reactor comprises a gas diffusion electrode and a catalyst comprising platinum or a non-precious metal.

44. The system of claim 31, wherein:
the CO₂ reduction reactor is fluidly coupled to the CO₂ capture subsystem; and
the hydrocarbon production subsystem comprises an autothermal reformer fluidly coupled to a Fischer-Tropsch (FT) reactor.

45. The system of claim 44, wherein the autothermal reformer comprises a reactant inlet configured to receive a combustible gas comprising at least one of an FT tail gas from the FT reactor, a refined tail gas, or a natural gas stream.

46. The system of claim 44, wherein the FT reactor comprises a syngas inlet configured to receive a syngas stream from the autothermal reformer.

47. The system of claim 44, wherein the FT reactor comprises an FT catalyst comprising at least one of nickel, cobalt, iron, or ruthenium.

48. The system of claim 44, wherein the CO₂ reduction reactor comprises an oxygen outlet that is fluidly coupled to the autothermal reformer and a carbon monoxide outlet that is fluidly coupled to the FT reactor.

49. The system of claim 44, wherein the FT reactor comprises a reactor volume containing a catalyst and at least one outlet configured to flow an FT tail gas to the autothermal reformer and an FT crude stream.

50. The system of claim 49, wherein the FT reactor is one of a fixed packed bed reactor, a multi-tubular fixed bed reactor, a fluidized bed reactor, and a slurry phase reactor.

51. The system of claim 31, wherein the hydrocarbon production subsystem comprises an autothermal reformer fluidly coupled to refining units, the refining units fluidly coupled to a distillation unit, the refining units comprising at least one outlet configured to flow a refined tail gas to the autothermal reformer and a refined crude to the distillation unit, the distillation unit configured to fractionate the refined crude into the synthetic fuel.

52. (canceled)

53. (canceled)

54. The system of claim 31, wherein:
the sorbent material comprises a CO₂ capture solution; and
the CO₂ capture subsystem comprises a burner configured to combust a combustible gas to provide thermal energy for heating the CO₂ capture solution, the combustible gas comprising at least one of a Fischer-Tropsch (FT) tail gas or a refined tail gas.

55. The system of claim 31, wherein:
the recovered carbon dioxide feed stream comprises excess oxygen; and
the system further comprises a catalytic oxidation reactor coupled to the CO₂ capture subsystem, the catalytic oxidation reactor operable to remove at least a portion of the excess oxygen, the catalytic oxidation reactor comprising:
a catalytic oxidation reactor volume containing a platinum-containing catalyst; and
at least one inlet configured to receive the excess oxygen in the recovered carbon dioxide feed stream and to receive a combustible gas comprising at least one of natural gas, a Fischer-Tropsch (FT) tail gas, or a refined tail gas,
the catalytic oxidation reactor volume configured to react the excess oxygen with the combustible gas over the platinum-containing catalyst.

56.-59. (canceled)

60. The system of claim 31, further comprising a CO₂ purification and compression system fluidly coupled to a liquid buffer storage tank configured to be pressurized to a pressure ranging between 10 bar to 65 bar, wherein the CO₂ capture subsystem is fluidly coupled to the hydrocarbon subsystem by the CO₂ purification and compression system and the liquid buffer storage tank.

61. The system of claim 60, wherein the CO₂ purification and compression system comprises at least one of a cryogenic distillation unit, a membrane separation unit, or water knockout unit.

62. The system of claim 31, wherein the hydrocarbon production subsystem comprises a Fischer-Tropsch (FT) reactor thermally coupled to the CO₂ capture subsystem.

63. The system of claim 62, wherein the CO₂ capture subsystem comprises a calciner, the FT reactor thermally coupled to the calciner.

64. (canceled)

65. The system of claim 31, further comprising a single compressor assembly fluidly coupled to the CO₂ capture subsystem and the hydrocarbon production subsystem, the single compressor assembly comprising a multi-stage compressor-motor or at least two compressors coupled to a single motor shaft.
